(19) United States
(12) Patent Application Publication
(10) Pub. No.: US 2012/0306721 A1
(43) Pub. Date: Dec. 6, 2012

(54) SHORTED PATCH ANTENNA DEVICE AND METHOD OF MANUFACTURING THEREFOR

(75) Inventors: Hirokatsu Okegawa, Chiyoda-ku (JP); Takanori Miyame, Chiyoda-ku (JP); Takashi Iwakura, Chiyoda-ku (JP); Yasuhiro Nishioka, Chiyoda-ku (JP); Takashi Yanagi, Chiyoda-ku (JP)

(73) Assignee: Mitsubishi Electric Corporation, Tokyo (JP)

(21) Appl. No.: 13/577,372

(22) PCT Filed: Jan. 24, 2011
(86) PCT No.: PCT/JP2011/000345

§ 371 Date: Aug. 6, 2012

(30) Foreign Application Priority Data
Feb. 5, 2010 (JP) 2010-024250

(51) Int. Cl. H01Q 1/36; H01P 11/00

(52) U.S. Cl. 343/905; 29/600

(57) ABSTRACT

The present invention relates to a novel shorted patch antenna device that a thickness of a conductor of an antenna, a location of a feeding point and a shape of an antenna element is easily adjustable and can be miniaturized, as well as a method therefor. The shorted patch antenna device includes: an antenna element that is composed of a folded single conductor plate and has a radiation conductor plane (2) formed on one of opposing planes of the conductor plate and a ground conductor plane (3) formed on the other plane of the opposing planes; a miniaturization section that is composed of a hole (5) formed on the ground conductor plane (3) and a slit (7) cut out from a side of the radiation conductor plane (2) or a matching adjustment plane (31) formed by bending a tip portion of the radiation conductor plane (2) toward the ground conductor plane (3); a coaxial line (8) whose inner conductor (9) extending through the hole (5) to the radiation conductor plane (2) is electrically connected to the radiation conductor plane (2) and whose external conductor (10) is grounded to the ground conductor plane (3); and a resin (16) that fills between the radiation conductor plane (2) and the ground conductor plane (3) of the antenna element.

### TECHNICAL FIELD

This invention relates to a shorted patch antenna device that can send and receive radio waves in such a way that, by short-circuiting a radiation conductor and a ground conductor, the radiation conductor resonates at ¼ wavelength of a frequency to be used, as well as a method of manufacturing the shorted patch antenna.

### BACKGROUND ART

In order to miniaturize a patch antenna (a microstrip antenna) in which a radiation conductor (patch) resonates at ½ wavelength of a frequency to be used, there is a shorted patch antenna using a method to have a radiation conductor (patch) resonate at ¼ wavelength of a frequency to be used by short-circuiting the radiation conductor and a ground conductor (see, for example, Non-Patent Literature 1). It has been known that this shorted patch antenna can allow a dimension of a side of the radiation conductor to be less or equal to ½ of a dimension of a side of the patch antenna.

A shorted patch antenna includes a shorted patch antenna to feed power through a microstrip line as described in Patent Literature 1 and a shorted patch antenna to feed power through a coaxial line as described in Patent Literature 2. A typical structure of a shorted patch antenna includes a structure in which a conductor layer is formed on a dielectric substrate (see, for example, FIGS. 1 and 3 in Patent Literature 1) and a structure formed by folding one sheet of metal plate (see, for example, FIGS. 1 through 7 and 10 in Patent Literature 2).

### PRIOR ART LITERATURE

### Patent Literature

Patent Literature 1: Unexamined Japanese Patent Application KOKAI Publication No. H8-222940
Patent Literature 2: National Publication No. 2002-530908

### Non-Patent Literature

Non-Patent Literature 1: Haneishi, M., Hirasawa, K., & Suzuki, Y. (1996) Kogata/Heimen Antenna (Small Planar Antennas) (pp 133 to 139), The Institute of Electronics, Information and Communication Engineers

### DISCLOSURE OF INVENTION

### Problem to be Solved by the Invention

A patch antenna is often used as a transmitting and receiving antenna used for a wireless communication device such as an antenna for a UHF or micro radio frequency identification (RFID, hereinafter referred to as RFID) reader/writer. Recently, an RFID system has become increasingly applied to an entrance and exit system, a process management system in a factory, and so on. However, in quite a lot of cases, a place where an antenna is located is restricted. Therefore, miniaturization of an antenna is desired.

However, a conventional shorted patch antenna has various problems, for example, that a structure is complicated, that miniaturization of a radiation conductor achieved by short-circuiting the radiation conductor and the ground conductor is not sufficient, and that a cross-polarization component cannot be increased.

Since a shorted patch antenna using a dielectric substrate has a wavelength shortening effect according to a relative permittivity of the dielectric substrate as shown in FIG. 1 of Patent Literature 1, the radiation conductor can be miniaturized. However, there is a limitation in thickening the dielectric substrate, and as a result, there is a limitation in increasing a current component in a short-circuit direction in a short-circuit conductor formed on the dielectric substrate, causing a problem that it is difficult to increase a current component to contribute a cross polarization. In the case where a short-circuit conductor has a through-hole as shown in FIG. 1 of Patent Literature 1, there is also a problem of a complicated structure. It is also difficult to form a short-circuit conductor pattern on a side surface of the dielectric substrate, instead of the through-hole. In the case where only a shorted patch (a radiation conductor and a short-circuit conductor) is composed of a metal plate (a sheet metal) as shown in FIG. 3 of Patent Literature 1, a current component that contributes to a cross-polarization can be increased by selecting a thick metal plate, which, however, causes a problem that a thickness of a whole antenna becomes thicker and a problem that the structure of an antenna becomes complicated.

Next, in the case where an antenna element of a shorted patch antenna is formed by folding one sheet of metal plate as described in Patent Literature 2, selecting a thick metal plate can increase a current component in a short-circuits direction, thereby increasing a current component that contributed to a cross-polarization. However, if a feeding point of an antenna needs to be set near a short-circuit end in order to achieve a desired antenna performance in the case FIGS. 7 and 10 of Patent Literature 2, the following problems occur: since an internal conductor (a central conductor) of a coaxial line needs to be folded intricately, a structure becomes complicated; a member (corresponding to “an extending leg 48” in Patent Literature 2) other than a metal plate needs to be connected to the metal plate in order to ground a coaxial line, a structure becomes complicated; change of a folding angle of a metal plate has an effect on impedance matching of a feeding point and a feeding line, and the like. There are also problems that since an antenna element is composed of a metal plate, the antenna element has a low impact resistance, is difficult to secure a dimensional tolerance, and has an irregular thickness of an antenna element.

The present invention has been made in order to solve the aforedescribed problems and is intended to provide a novel shorted patch antenna device that has a simple structure, can easily adjust a conductor thickness of an antenna, a location of a feeding point and an antenna element shape, and can be miniaturized, as well as a method of manufacturing the shorted patch antenna device.

### Means to Solve the Problem

A shorted patch antenna device according to the present invention includes: an antenna element that is composed of a folded single conductor plate and has a radiation conductor plane formed on one of opposing planes of the conductor plate and a ground conductor plane formed on the other of the opposing planes of the conductor plate;

a miniaturization section that is composed of a slit formed by cutting out a side of the radiation conductor plane or a matching adjustment plane formed by bending a tip of the radiation conductor plane toward the ground conductor plane;

a coaxial line whose internal conductor extending from the ground conductor plane end to the radiation conductor plane is electrically connected to the radiation conductor plane and whose external conductor is grounded to the ground conductor plane; and

a resin that fills between the radiation conductor plane and the ground conductor plane of the antenna element.

A method of manufacturing a shorted patch antenna device according to the present invention includes: a conductor plate processing step to form a U-shaped notch on a conductor plate, a slit in a region opposing with respect to a region of the conductor plate where the U-shaped notch is formed to a region of the conductor plate surrounded by the U-shaped notch and a hole in a region opposing with respect to the region of the conductor plate where the U-shaped notch is formed to the region of the conductor plate where the slit is shaped, the slit being formed by cutting out a side of the conductor plate; a first folding step to fold tips of a fork portion of the U-shaped notch on the conductor plate so as to convert the U-shaped notch to an opening, thereby causing a region of the conductor plate where the U-shaped notch is formed and a region of the conductor plate where the hole is formed to be in different flat planes; a second folding step to fold the conductor plate between the U-shaped notch or the opening and the slit, thereby causing a region of the conductor plate where the U-shaped notch or the opening is formed and a region of the conductor plate where the slit is formed to be in different flat planes; a conductor plate opposing step to allow a region of the conductor plate where the hole is formed and a region of the conductor plate where the slit is formed opposite each other; a coaxial line mounting step to affix a coaxial line to the conductor plate in such a way that an external conductor is electrically connected and an internal conductor extends through the hole and is electrically connected to a region of the conductor plate where the slit is formed, the external conductor mounting section that continues from a region of the conductor plate where the hole is formed and extends from a portion at which the region of the conductor plate where the hole is formed abuts on the opening; a sealing step to fill a resin around the conductor plate at least with the slit being exposed, after the coaxial line mounting step; and a slit adjustment step to change dimensions of the slit after the sealing step.

### Effects of the Invention

The present invention can provide a small shorted patch antenna having a stable performance, in which an antenna element, which includes a radiation conductor plane and a ground conductor plane, is composed of one sheet of conductor plate thereby to easily miniaturize the whole device with the use of resin and a miniaturization section; a main component of a coaxial line in a space between the radiation conductor plane and ground conductor plane that compose the antenna element can be an internal conductor thereby to increase options for a location setting of a feeding point on the radiation conductor plane; and the radiation conductor plane and ground conductor plane is fixed by resin that fills between the radiation conductor plane and the ground conductor plane of the antenna element and the slits can be adjusted thereby to easily adjust impedance mismatching between a feeding point (antenna element) and a feeding line (coaxial line) due to a dimensional tolerance of the conductor plate being matched.

The present invention also can provide a method of manufacturing a small shorted patch antenna having a stable performance, in which an antenna element is formed by processing and folding one sheet of conductor plate thereby to easily miniaturize the whole device with the use of resin and slits; a main component of a coaxial line in a space between the radiation conductor plane and the ground conductor plane that compose the antenna element can be an internal conductor thereby to increase options for a location setting of a feeding point on the radiation conductor plane; and slits can be adjusted thereby to easily adjust impedance mismatching between a feeding point (antenna element) and a feeding line (coaxial line) due to a dimensional tolerance of the conductor plate being matched.

### BRIEF DESCRIPTION OF DRAWINGS

FIG. 1 is a transparent view of a shorted patch antenna device according to a first embodiment of the present invention;

FIG. 2 is a manufacturing process diagram of a conductor plate that is used for the shorted patch antenna device according to the first embodiment of the present invention;

FIG. 3 is a manufacturing process diagram of the conductor plate that is used for the shorted patch antenna device according to the first embodiment of the present invention;

FIG. 4 is a manufacturing process diagram (an image illustration of a cross section) of an antenna element that is used for the shorted patch antenna device according to the first embodiment of the present invention;

FIG. 5 is a manufacturing process diagram (an image illustration of a cross section) of the shorted patch antenna device according to the first embodiment of the present invention;

FIG. 6 is a manufacturing process diagram (an image illustration of a cross section) of the antenna element that is used for the shorted patch antenna device according to the first embodiment of the present invention;

FIG. 7 is a manufacturing process diagram (an image illustration of a cross section) of the shorted patch antenna device according to the first embodiment of the present invention;

FIG. 8 is a transparent view of a shorted patch antenna device according to a second embodiment of the present invention;

FIG. 9 is a manufacturing process diagram (an image illustration of a cross section) of an antenna element that is used for the shorted patch antenna device according to the second embodiment of the present invention;

FIG. 10 is a manufacturing process diagram (an image illustration of a cross section) of the shorted patch antenna device according to the second embodiment of the present invention;

FIG. 11 is a view (an image illustration of a cross section) of the antenna element that is used for the shorted patch antenna device according to the second embodiment of the present invention;

FIG. 12 is a manufacturing process diagram (an image illustration of a cross section) of an antenna element that is used for a shorted patch antenna device according to a third embodiment of the present invention;

FIG. 13 is a manufacturing process diagram (an image illustration of a cross section) of the shorted patch antenna device according to the third embodiment of the present invention;

FIG. 14 is an explanatory diagram of a slit adjustment step of the shorted patch antenna device according to the third embodiment of the present invention;

FIG. 15 is a transparent view of a shorted patch antenna device according to a fourth embodiment of the present invention;

FIG. 16 is a transparent view of the shorted patch antenna device according to the fourth embodiment of the present invention;

FIG. 17 is a transparent view of the shorted patch antenna device according to the fourth embodiment of the present invention;

FIG. 18 is a non-transparent perspective view of a housing of the shorted patch antenna device according to the first through fourth embodiments of the present invention;

FIG. 19 is a transparent view of a shorted patch antenna device according to a fifth embodiment of the present invention;

FIG. 20 is a manufacturing process diagram of a conductor plate that is used for the shorted patch antenna device according to the fifth embodiment of the present invention;

FIG. 21 is a view of an antenna configuration as seen through the housing and a dielectric (resin) of the shorted patch antenna device according to the first through fifth embodiments of the present invention (Arrow F indicates a front face direction of the antenna);

FIG. 22 is a view of a housing configuration of a shorted patch antenna device for comparing the first through fifth embodiments with a sixth embodiment (Arrow F indicates a front face direction of the antenna);

FIG. 23 is a transparent view of the shorted patch antenna device according to the sixth embodiment of the present invention;

FIG. 24 is a transparent view of the shorted patch antenna device according to the sixth embodiment of the present invention;

FIG. 25 is a transparent view of the shorted patch antenna device according to the sixth embodiment of the present invention;

FIG. 26 is a view of configuration of a conductor plate that is used for the shorted patch antenna device according to the sixth embodiment of the present invention;

FIG. 27 is a manufacturing process diagram of the conductor plate that is used for the shorted patch antenna device according to the sixth embodiment of the present invention; and

FIG. 28 is a manufacturing process diagram of the conductor plate that is used for the shorted patch antenna device according to the sixth embodiment of the present invention.

### EXPLANATION OF REFERENCE NUMERALS

1. conductor plate
2. radiation conductor plane (radiation conductor, patch)
3. ground conductor plane (ground conductor)
4. short-circuit plane (short-circuit conductor)
5. hole
6. hole
7. slit
8. coaxial line
9. internal conductor
9a. electrical connection means
10. external conductor
10a. electrical connection means
11. insulating coating
12. bushing
13. heat shrinkable tube
14. housing
15. rib
16. resin
17. opening
18. external conductor mounting section
19. notch
20. linear conductor
20a. electrical connection means
20b. electrical connection means
21. insulating coating
22. linear conductor
22a. electrical connection means
22b. electrical connection means
23. insulating coating
24. spacer
25. slit
26. portion whose conductor is scraped off
27. slit
28. additional conductor
29. housing
30. concave portion
31. matching adjustment plane
32. external conductor mounting section

### BEST MODE FOR CARRYING OUT THE INVENTION

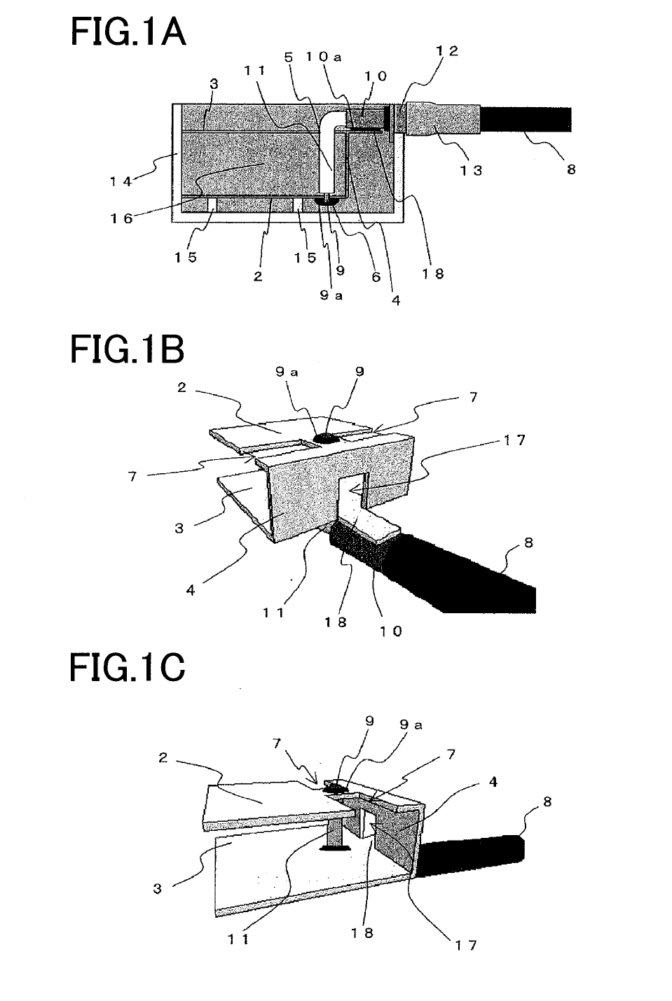

In the present invention, an image illustration of a cross section is a cross sectional view where a coaxial line penetrates through a conductor plate composing an antenna element, and the coaxial line is seen from a side surface, not a cross section. In FIGS. 1 through 18, an end of a coaxial line opposite to an end connected to an antenna element looks to be cut. Actually, however, the opposite end is connected to a wireless communication device such as an RFID reader/writer, but the wireless communication device to which the opposite end is connected is not illustrated in FIGS. 1 through 18. Further, in some of the FIGS, a resin bushing and a heat shrinkable tube that are mounted to the coaxial line are not illustrated.

### First Embodiment

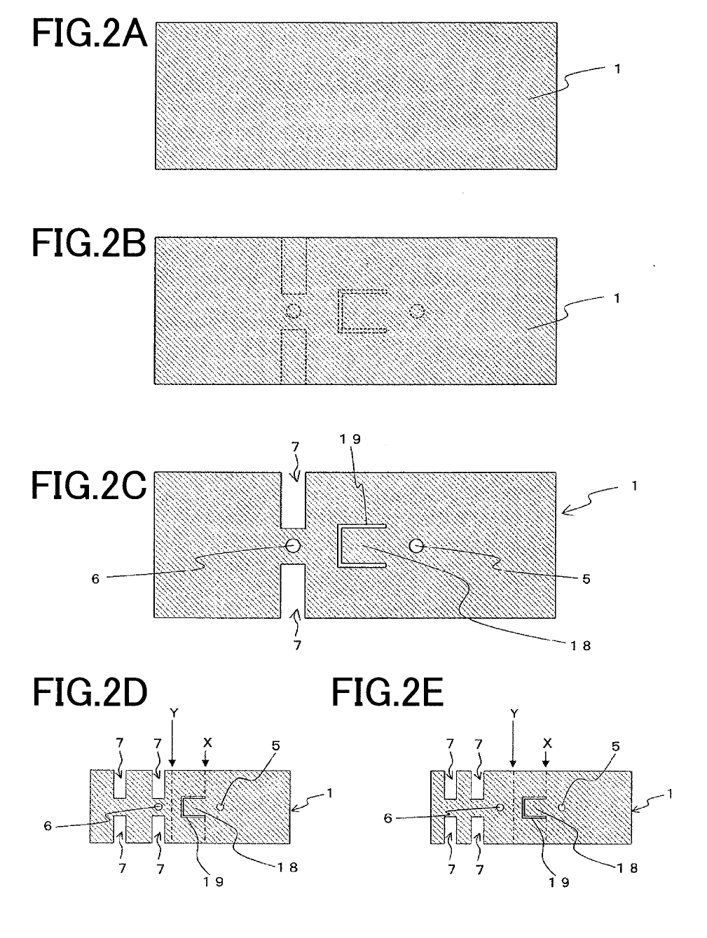

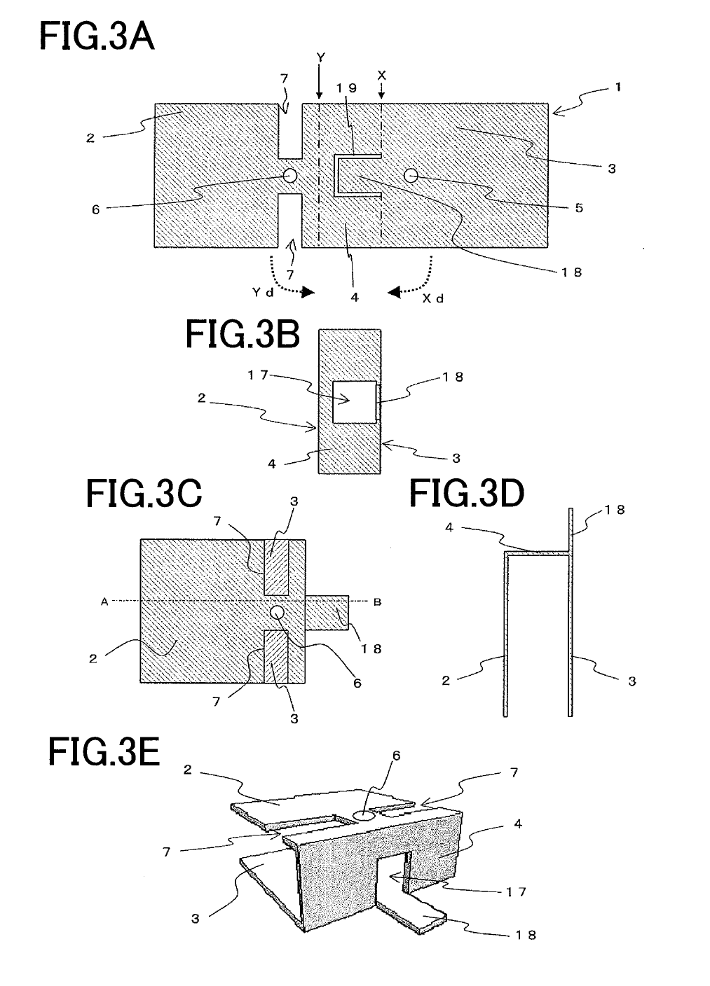

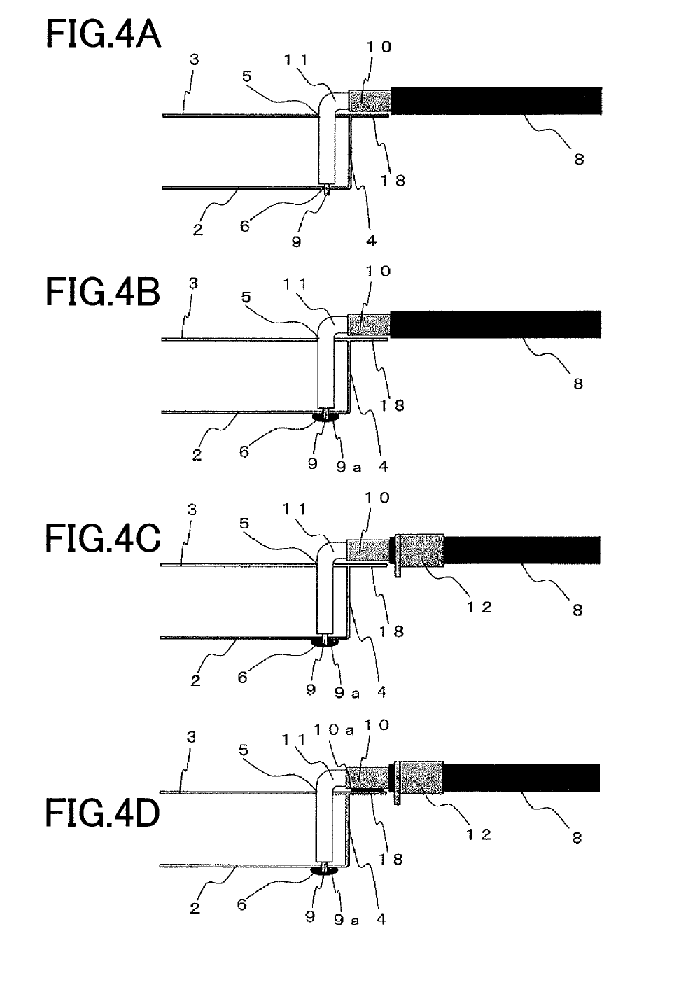

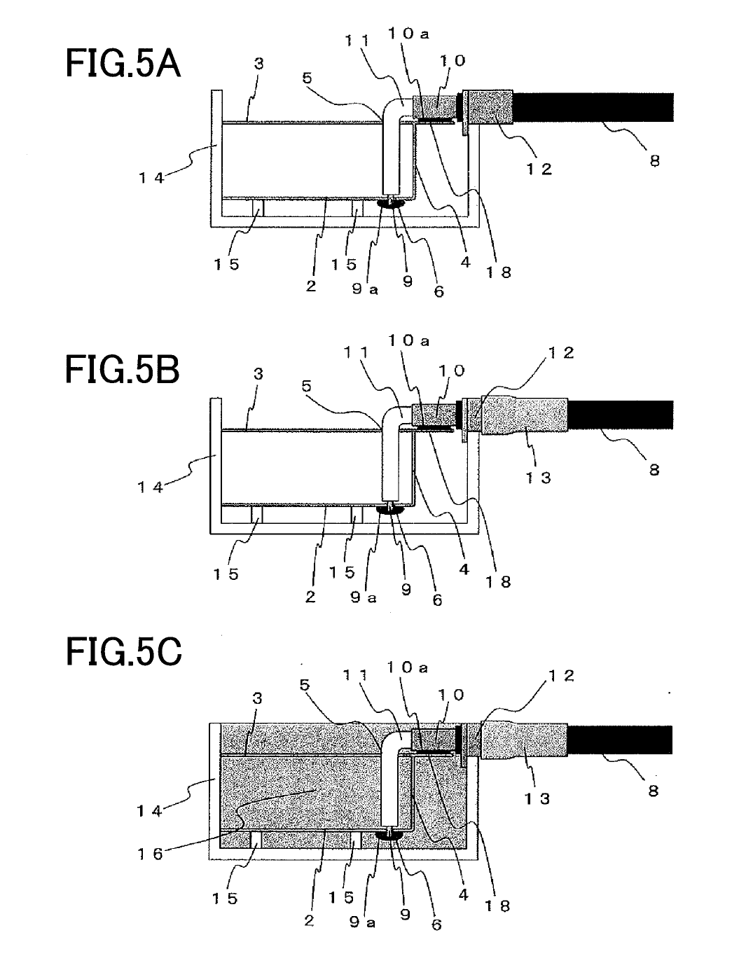

Hereinafter, a first embodiment of the present invention will be described with reference to FIGS. 1 through 7. FIG. 1A is a view of an antenna configuration as seen through a side surface of a housing of a shorted patch antenna device. FIGS. 1B and 1C are views of an antenna configuration as seen through the housing and a dielectric (resin) of the shorted patch antenna device. FIG. 2A is a top view of a single conductor plate. FIG. 2B is a conceptual diagram illustrating a shape to be processed on the single conductor plate. FIGS. 2C and 3A are top views of the single conductor plate that has been subjected to conductor plate processing. FIGS. 2D and 2E are top views of the single conductor plate that has been subjected to conductor plate processing (in the case where a plurality of two slits is formed). FIG. 3B is a view of the single conductor plate that has been subjected to conductor plate opposing, seen from a short-circuit plane (opening) end. FIG. 3C is a view of the single conductor plate that has been subjected to conductor plate opposing, seen from a radiation conductor plane end. FIG. 3D is a cross-sectional view of the conductor plate taken from dashed-dotted line AB in FIG. 3C. FIG. 3E is a perspective view of the single conductor plate that has been subjected to conductor plate opposing. FIG. 4A is a view where a coaxial line is inserted into an antenna element. FIG. 4B is a view where an internal conductor of the coaxial line is soldered to a radiation conductor plane of the antenna element. FIG. 4C is a view where an insulating bushing is attached to the coaxial line. FIG. 4D is a view where an external conductor of the coaxial line is soldered to an external conductor mounting section of the antenna element. FIG. 5A is a view where the antenna element to which the coaxial line is connected is placed in the housing. FIG. 5B is a view where a heat shrinkable tube is attached to the coaxial line. FIG. 5C is a view where a dielectric resin fills the housing to seal the antenna element.

In FIGS. 1 through 5, 1 indicates a single (one sheet of) conductor plate (including a pre-folded one and a folded one for convenience of description); 2 indicates a radiation conductor plane (including a pre-folded conductor plate 1 for convenience of description) that is composed of a folded single conductor plate 1 and formed on one plane of the opposing planes of the conductor plate 1; 3 indicates a ground conductor plane (including a pre-folded conductor plate 1 for convenience of description) that is composed of a folded single conductor plate 1 and formed on the other plane of the opposing planes of the conductor plate 1; 4 is a short-circuit plane (including a pre-folded conductor plate 1 for convenience of description) that is composed of a folded single conductor plate 1 in which short-circuits the radiation conductor plane 2 and the ground conductor plane 3. Since the radiation conductor plane 2, ground conductor plane 3 and short-circuit plane 4 are formed by folding (bending) the conductor plate 1, they are described by the word “plane”. However, as an antenna element, the radiation conductor plane 2, ground conductor plane 3 and short-circuit plane 4 may be described as a radiation conductor 2 (patch 2), a ground conductor 3 and a short-circuit conductor 4. In the drawings, the same reference number indicates an identical or corresponding portion, which will not be described in detail.

In FIGS. 1 through 5, 5 indicates a hole formed on the ground conductor plane 3; 6 indicates a hole that is formed on the radiation conductor plane 2 and corresponds to a feeding point of the shorted patch antenna device. 7 indicates two slits that face each other and are formed from both of two opposing sides of the radiation conductor plane 2, and a shape of each of the slits is not limited to be a rectangular shape as illustrated, but may be a cutout that is formed on the radiation conductor plane 2 and has any shape as long as the shape has a wavelength shortening effect. The slits 7 do not have to be formed on two opposing sides of the radiation conductor plane 2, but may be formed on only one side (a slit 7 formed by cutting out a side of the radiation conductor plane 2), or a plurality of slits may be formed along the two opposing sides of the radiation conductor plane 2. In this way, the slits 7 function as a miniaturization section that can miniaturize an area of the radiation conductor plane 2, especially, an area of a plane opposing the ground conductor plane 3. 8 indicates a coaxial line such as a coaxial cable; 9 indicates an internal conductor of the coaxial line 8; 9a indicates an electrical connection means such as soldering to electrically connect the internal conductor 9 inserted into the hole 6; indicates an external conductor of the coaxial line 8; 11 indicates a cylindrical insulating coating that coats the internal conductor; and 12 indicates a resin bushing; 13 indicates a heat shrinkable tube. The coaxial line 8 has the insulating coating 11 between the internal conductor 9 and the external conductor 10, and the insulating coating 11 insulates the internal conductor 9 from the external conductor 10. In the present invention, description will be made with reference to a case where an outermost portion of the coaxial line 8, that is, the external conductor 10 is coated with a cylindrical insulating coating. In drawings, a portion illustrated as the coaxial line 8 indicates an insulating coating that is an outermost portion of the coaxial line 8. In the drawings, the same reference number indicates an identical or corresponding portion, which will not be described in detail.

In FIGS. 1 through 5, 14 indicates a housing that has an opening and a bottom that are surrounded by four side surfaces, the bottom holding the antenna element, an edge of the housing being provided with a concave portion and a hole to affix or locate the coaxial line 8 (including the bushing 12). 15 indicates a rib that is located on the bottom of the housing 14 and supports the antenna element, and the ribs 15 may be integrated into or separate from the housing 14. If the antenna element is placed in the housing 14 with the radiation conductor plane 2 opposing the ribs 15, a shape of the ribs may be a projection that fits into the slit 7. This fitting includes a state where the rib and slit do not tightly engage with each other. Further, the housing 14 may not have the ribs 15. 16 indicates a dielectric resin (corresponding to a dielectric substrate) that is a thermo-setting resin such as an epoxy resin. The bushing 12 and heat shrinkable tube 13 prevent the resin 16 that fills the housing 14 from leaking from the housing 16, and the bushing 12 and heat shrinkable tube 13 may be integrated. 17 indicates an opening of the short-circuit plane 4 that is cut out at least to the ground conductor plane 3. 18 indicates an external conductor mounting section (including a pre-folded conductor plate 1 and the conductor plate 1 that has not yet contacted the coaxial line 8, for convenience of description) that is part of the conductor plate 1 and extends from where the ground conductor plane 3 abuts on the opening 17 on the short-circuit plane 4. The external conductor 10 of the coaxial line 8 contacts with the external conductor mounting section 18 thereby to ground the coaxial line 8 to the ground conductor plane 3. 10a indicates an electrical connection means such as soldering to electrically connect the external conductor 10 to the external conductor mounting section 18; 19 indicates a U-shaped notch formed on the conductor plate 1, and the conductor plate 1 is folded to make the notch 19 open thereby to become the opening 17 and external conductor mounting section 18. In the drawings, the same reference number indicates an identical or corresponding portion, which will not be described in detail.

In a structure of the shorted patch antenna device according to the first embodiment illustrated in FIG. 1, an antenna element whose radiation conductor plane 2 (patch) is grounded to the ground conductor plane 3 by the short-circuit plane 4, the coaxial line 8 feeds power to the antenna element, and the antenna element and coaxial line 8 are held in the housing 14. The housing 14 encapsulates the resin 16 that fills around the antenna element. Accordingly, the housing 14 allows a dielectric layer of the resin 16 to be easily formed in a space surrounded by the radiation conductor plane 2, ground conductor plane 3 and short-circuit plane 4 that are composed of the conductor plate 1, thereby obtaining a wavelength shortening effect according to a relative permittivity of the resin 16, which leads to miniaturization of the antenna element (radiation conductor plane 2) of the shorted patch antenna device. Further, since the slits 7 cut out in the same direction as a folding direction of the conductor plate 1 are formed on the radiation conductor plane 2 that is a radiation plane of the antenna, a wavelength shortening effect due to the slits 7 shortens the radiation conductor plane 2, thereby further miniaturizing the shorted patch antenna device.

In FIGS. 1A through 1C, a feeding point of the shorted patch antenna device according to the first embodiment is placed between two opposing slits 7 on the radiation conductor plane 2. A location of the feeding point is not limited to this location as long as the feeding point is on the radiation conductor plane 2 (The same applies to other embodiments, with respect to the feeding point). The shorted patch antenna device according to the first embodiment has a simple structure in which the resin 16 fills a space between the radiation conductor plane 2 and the ground conductor plane 3 that compose the antenna element, and into the space the internal conductor 9 or the internal conductor 9 with the insulating coating 11 is inserted through the hole 5 of the ground conductor plane 3. Therefore, the external conductor 10 of the coaxial line 8 is grounded to the external conductor mounting section 18 thereby to affix the coaxial line 8 to the housing 14 without feeding with the use of a coaxial connector, allowing for miniaturization of the whole device. Further, even if dimensional adjustment of the antenna (conductor plate 1) performed to match impedance between the feeding point and a feeding line (coaxial line 8) needs to move the feeding point toward the short-circuit plane 4, the feeding point can be easily moved due to the simple structure without a member other than the conductor plate 1 or the aforedescribed coaxial connector as illustrated in FIG. 1, especially FIG. 1C.

Next, a method of manufacturing the shorted patch antenna device according to the first embodiment will be described with reference to FIGS. 2 through 5. First, a procedure to fold a sheet of conductor plate 1 to obtain an antenna element will be described with reference to FIGS. 2 and 3. FIG. 2A illustrates a top surface of a pre-folded conductor plate 1 that will become the antenna element. First, in a conductor plate processing step, the U-shaped notch 19, two slits 7, hole 5 and hole 6 are formed on the conductor plate 1 in such a way that the two slits 7 are formed in a region opposing a region of the conductor plate 1 surrounded by the U-shaped notch (a region designated to become the radiation conductor plane 2), the two slits 7 are formed from two opposing sides of the conductor plate 1 with the two slits 7 opposing each other, the hole 5 is formed in a region (a region designated to become the ground conductor plane 3) opposing with respect to the U-shaped notch 19 a region of the conductor plate 1 where the slits 7 are formed, and the hole 6 is formed in the region where the two slits 7 are formed. In the conductor plate processing step, a common sheet metal processing may be used to process a dotted line portion of the conductor plate 1 illustrated in FIG. 2B. The order to form the U-shaped notch 19, slits 7, hole 5 and hole 6 is not limited. The U-shaped notch 19, slits 7, hole 5 and hole 6 may be formed simultaneously by punching or the like. A shape of the U-shaped notch 19 may be linear as illustrated in FIGS. 2B and 2C, or rounded. In the present invention, U-shaped includes V-shaped and C-shaped. That is because since the notch 19 is formed in the short-circuit plane 4, which is a short-circuit conductor, of the antenna element, the notch 19 does not have much effect on operation of the shorted patch antenna device.

In the conductor plate processing step, the conductor plate 1 illustrated in FIG. 2C is obtained. In order to fold this conductor plate 1 to obtain opposing conductors that compose the antenna element, a conductor plate opposing step is performed to cause a region of the conductor plate 1 where the hole 5 is formed and a region of the conductor plate 1 where the hole 6 and slits 7 are formed to face each other. The conductor plate opposing step is composed of a first folding step and a second folding step illustrated in FIG. 3, and the order of performing the first folding step and second folding step is not limited. The first folding step and second folding step may be simultaneously performed, or the aforedescribed conductor plate processing step may be performed simultaneously with the first folding step and second folding step. The conductor plate processing step may be performed after the conductor plate opposing step. By subjecting the conductor plate 1 to conductor plate processing and conductor plate opposing, the conductor plate 1 is obtained in such a shape that the external conductor mounting section 18, which is part of the conductor plate 1, projects from a line segment (a side) where the short-circuit plane 4 including opening 17 and the ground conductor plane 3 abut on each other, as illustrated in FIGS. 3B through 3E. These processing steps cause the ground conductor plane 3 and the external conductor mounting section 18 to become near-horizontally aligned, but they may be angled to each other.

The conductor plate processing step has been described with reference to a case where the two slits 7 (one unit of slits 7 is composed of two slits) are formed at one place of the radiation conductor plane 2 illustrated in FIGS. 2A through 2C. A plurality of units of two slits 7 may be formed along the two opposing sides of the radiation conductor plane 2. In such a case, the radiation conductor plane 2 can be further miniaturized. As illustrated in FIGS. 2D and 2E, an example of such a case includes forming two units of the two slits 7 at two opposing positions. In FIG. 2D, the hole 6 (feeding point) is located between the two slits 7 formed near the short-circuit plane 4. In FIG. 2E, the hole 6 (feeding point) is located in a region other than between the two opposing slits 7. Folding lines X and Y illustrated in FIGS. 2D and 2E will be described in detail in a conductor plate opposing step. The same conductor plate opposing step applies to the conductor plate 1 illustrated in FIGS. 2C through 2E.

In the first folding step, tips of the fork portion of the U-shaped notch 19 on the conductor plate 1 are folded so as to convert the U-shaped notch 19 to the opening 17, thereby causing a region of the conductor plate 1 where the U-shaped notch 19 is formed and a region of the conductor plate 1 where the hole 5 is formed to be in different flat planes and causing the ground conductor plane 3 and the short-circuit plane 4 to be angled at a less or equal to 180 degree angle. Specifically, the folding line X illustrated in FIG. 3A is folded in the folding direction of Xd in the first folding step.

In the second folding step, a region between the U-shaped notch 19 or opening 17 and the slits 7 of the conductor plate 1 is folded thereby to cause the region of the conductor plate 1 where the U-shaped notch 19 or opening 17 is formed and the region of the conductor plate 1 where the hole 6 and slits 7 are formed to be in different flat planes and causing the radiation conductor plane 2 and the short-circuit plane 4 to be angled at a less or equal to 180 degree angle. Specifically, the folding line Y illustrated in FIG. 3A is folded in the folding direction of Yd in the second folding step.

The conductor plate 1 that has been subjected to the conductor plate opposing composes the antenna element. The antenna element has a shape as illustrated in FIGS. 3B through 3E. FIGS. 3B, 3D and 3E show that the opening 17 is formed on the short-circuit plane 4, and the external conductor mounting section 18 is located at the ground conductor plane 3 end of the opening 17. FIGS. 3C and 3E show that the slits 7 are formed on the radiation conductor plane 2. The ground conductor plane 3 can be seen through the slits 7.

After the conductor plate processing and conductor plate opposing step, by mounting (affixing) the coaxial line 8 to the conductor plate 1, the antenna element is completed (in some cases, the term, antenna element is used for the conductor plate 1 to which the coaxial line 8 has not been mounted yet, in the present invention). A coaxial line mounting step to mount the coaxial line 8 will be described with reference to FIG. 4. First, the internal conductor 9 is exposed from a tip of the coaxial line 8, and next to the tip, the internal conductor 9 with the insulating coating 11 is exposed and the insulating coating 11 covered with the external conductor 10 is then exposed in this order. As illustrated in FIG. 4A, the coaxial line 8 is inserted through the hole 5 into the ground conductor plane 3, a tip portion of the internal conductor 9 of coaxial line 8 extends to the hole 6 and is inserted into the hole 6. Next, as illustrated in FIG. 4B, the tip portion of the internal conductor 9 inserted into the hole 6 is electrically connected and affixed by the electrical connection means 9a. This conducts electricity between the internal conductor 9 of the coaxial line 8 and the radiation conductor plane 2. The conduction between the internal conductor 9 of the coaxial line 8 and the radiation conductor plane 2 may be achieved by directly soldering the internal conductor 9 of the coaxial line 8 to the radiation conductor plane 2 (a portion of the feeding point) without forming the hole 6 on the radiation conductor plane 2. Next, the bushing 12 is attached to the coaxial line 8 (FIG. 4C). Then, as illustrated in FIG. 4D, the external conductor 10 is electrically connected by an electrical connection means 10a to the external conductor mounting section 18 that is a region continuing from a region of the conductor plate 1 where the hole 5 is formed and extending from a portion where the region of the conductor plate 1 where the hole 5 is formed abuts on the opening 17. The order of steps in FIGS. 4B, 4C and 4D is not limited.

By placing the antenna element to which the coaxial line 8 is mounted in the housing 14 and filling the resin 16 around the conductor plate 1, the shorted patch antenna device according to the first embodiment is completed. A lid may be attached to the housing 14 after the resin 16 becomes solidified, or one surface of the solidified resin 16 is used as an outer shell of the shorted patch antenna device according to the first embodiment, as illustrated in FIG. 5C. Here, an antenna element placement step and a sealing step will be described in detail. First, as illustrated in FIGS. 5A and 5B, the radiation conductor plane 2 is placed on the ribs 15 on the bottom of the housing 14, and the bushing 12 is placed on the edge of the housing 14. Next, the heat shrinkable tube 13 is attached to the bushing 12 and coaxial line 8 and subjected to heat treatment thereby to affix the bushing 12 to the coaxial line 8 with the use of the heat shrinkable tube 13. Finally, the resin 16 is injected into the housing 14. During injection, since the resin 16 flows from between the radiation conductor plane 2 and the ground conductor plane 3 of the antenna element into the housing 14 end through the opening 17 and slits 7 (excluding a case where the slits 7 fit onto the rib 15), or vice versa, the resin 16 can effectively fill within the whole housing 14. That is, the housing 14 having excessively large dimensions relative to dimensions of the antenna element is not required, and in the case that the housing 14 is used as an outer shell of the shorted patch antenna device according to the first embodiment, thereby directly contribute to miniaturization. FIG. 5C illustrates the shorted patch antenna device after the resin becomes solidified.

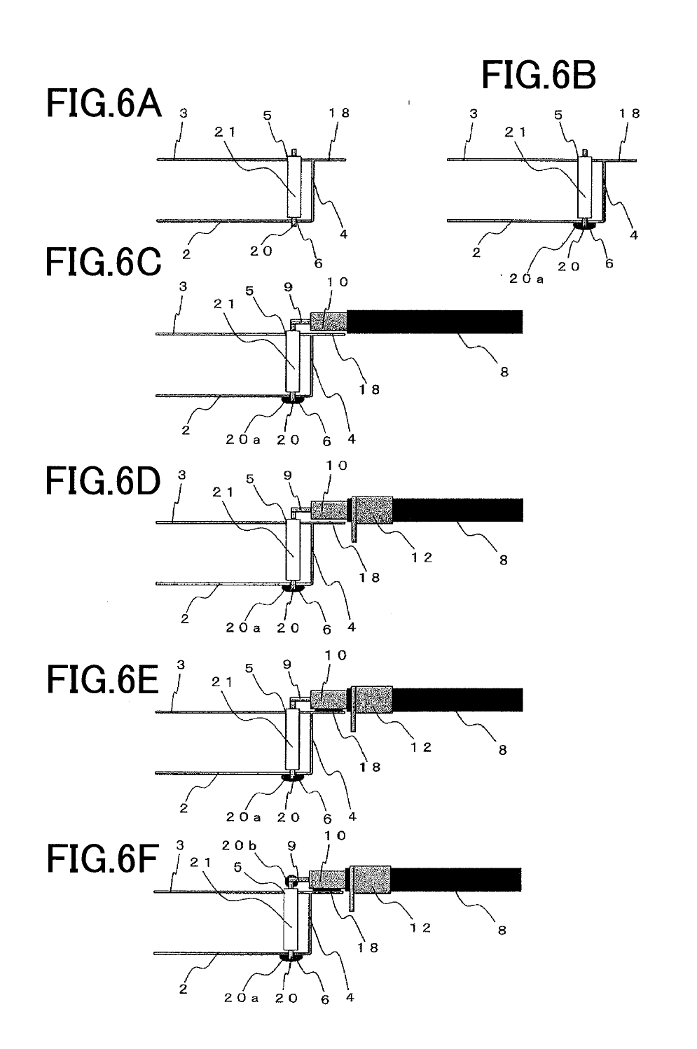

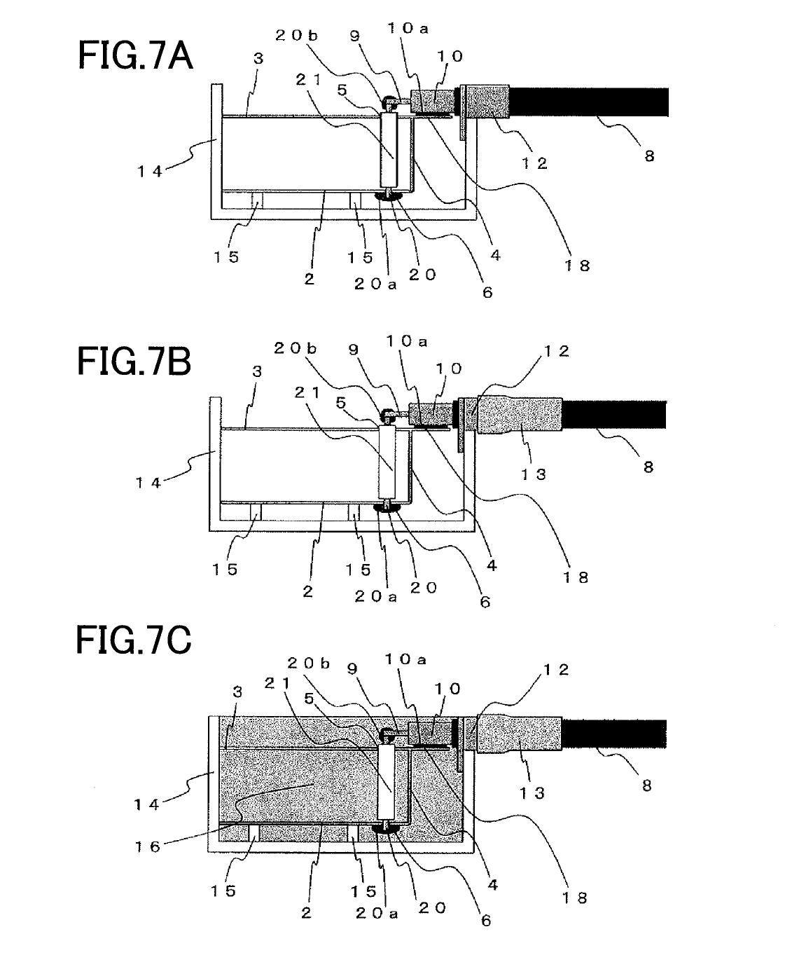

Next, a variation of the shorted patch antenna device according to the first embodiment will be described with reference to FIGS. 6 and 7. A difference of the variation from the antenna element and shorted patch antenna device illustrated in FIGS. 4 and 5 is that, with respect to a portion corresponding to the internal conductor 9 of the coaxial line 8, a member of a portion at least from the hole 5 to the radiation conductor plane 2 and a member of a portion other than the aforementioned portion are different from each other. In such a case, a conductor having a shape superior to that of the internal conductor 9 in encapsulating the resin can be employed for the portion from the hole 5 to the radiation conductor plane 2. A variation (a method of manufacturing) of the shorted patch antenna device according to the first embodiment is different from the method of manufacturing the shorted patch antenna device according to the first embodiment in the coaxial line mounting step, which will be described.

FIG. 6A is a view where a conductor covered with an insulating coating is inserted into the antenna element; FIG. 6B is a view where the conductor covered with an insulating coating is soldered to the radiation conductor plane of the antenna element; FIG. 6C is a view where the internal conductor of the coaxial line contacts with the conductor covered with an insulating coating; FIG. 6D is a view where the insulating bushing is attached to the coaxial line; FIG. 6E is a view where the external conductor of the coaxial line is soldered to the external conductor mounting section of the antenna element; and FIG. 6F is a view where the internal conductor of the coaxial line is soldered to the conductor covered with the insulating coating. FIG. 7A is a view where the antenna element connected to the coaxial line is placed in the housing; FIG. 7B is a view where the heat shrinkable tube is attached to the coaxial line; and FIG. 7C is a view where a dielectric resin fills the housing thereby to seal the antenna element. In FIGS. 6 and 7, 20 indicates a linear conductor; 20a indicates an electrical connection means such as soldering that electrically connects the linear conductor 20 to the radiation conductor plane 2; 20b indicates an electrical connection means such as soldering that electrically connects the linear conductor 20 to the internal conductor 9; 21 indicates an insulating coating that coats the linear conductor 20 with a tip end and a base end exposed. In the drawings, the same reference number indicates an identical or corresponding portion, which will not be described in detail.

A coaxial line mounting step in the variation will be described with reference to FIG. 6. First, the internal conductor 9 is exposed from the tip portion of the coaxial line 8, and at a portion next to the tip portion the insulating coating 11 is covered with the external conductor 10 is exposed. Meanwhile, as illustrated in FIG. 6A, the linear conductor 20 covered with the insulating coating 21 is inserted through the hole 5 into the conductor plate 1, and a tip portion of the linear conductor 20 is inserted into the hole 6. Next, as illustrated in FIG. 6B, the tip portion of the linear conductor 20 inserted into the hole 6 is electrically connected and affixed by the electrical connection means 20a. This conducts electricity between the linear conductor 20 and the radiation conductor plane 2. Conduction between the linear conductor 20 and the radiation conductor plane 2 may be achieved by soldering the linear conductor 20 directly to the radiation conductor plane 2 (feeding point portion) without forming the hole 6 in the radiation conductor plane 2. The tip portion of the internal conductor 9 of the coaxial line 8 is brought into contact with the base end portion (the hole 5 end) of the linear conductor 20 (FIG. 6C). Next, the bushing 12 is attached to the coaxial line 8 (FIG. 6D). Then, as illustrated in FIG. 6E, the external conductor 10 is electrically connected by the electrical connection means 10a to the external conductor mounting section 18 that is a region continuing from a region of the conductor plate 1 where the hole 5 is formed and extending from a portion at which the region of the conductor plate 1 where the hole 5 is formed abuts on the opening 17. As illustrated in FIG. 6F, the tip portion of the internal conductor 9 of the coaxial line 8 is electrically connected by the electrical connection means 20b to the base end portion (the hole 5 end) of the linear conductor 20. The order of steps in FIGS. 6B through 6F is not limited.

By placing the antenna element to which the coaxial line 8 is mounted in the housing 14 and filling the resin 16 around the conductor plate 1, the shorted patch antenna device (variation) according to the first embodiment is completed. The antenna element placement step and sealing step in FIG. 7 are basically the same as those described with reference to FIG. 5 except that the configuration of the coaxial line 8 is different, which therefore will not be described. However, in the shorted patch antenna device (variation) according to the first embodiment, since, as described, with respect to a portion corresponding to the internal conductor 9 of the coaxial line 8, a member of a portion at least from the hole 5 to the radiation conductor plane 2 is different from a member of a portion other than the aforementioned portion (linear conductor 20), the internal conductor 9 does not need to be bent. That is, in the shorted patch antenna device according to the first embodiment, the minimum bending radius in which the internal conductor 9 can be bent without being broken decides a range where the feeding point can be placed (especially, near the short-circuit plane 4). However, in the shorted patch antenna device according to this variation, by placing linearly the internal conductor 9 and the linear conductor 20 without being bent, the minimum bending radius in which the internal conductor 9 can be bent without being broken does not need to be taken into consideration. As illustrated in FIG. 7C, in the shorted patch antenna device after the resin becomes solidified, since a connecting portion of the internal conductor 9 and linear conductor 20 is sealed by the resin in the housing 14, a strength of the connecting portion is not practically different from a strength in the case where the linear conductor 20 is not used. (Even if the electrical connection means 20b is exposed out of the resin 16, there is no problem as long as the strength of the electrical connection means 20b is secured). Further, also in the antenna element placement step in FIGS. 7A and 7B, since the antenna element including the coaxial line 8 and linear conductor 20 is supported by the ribs 15 and bushing 12 in the housing 14, the connecting portion of the internal conductor 9 and the linear conductor 20 is not subjected to a load that will cause a bad connection between the internal conductor 9 and the linear conductor 20 before and after the sealing step.

### Second Embodiment

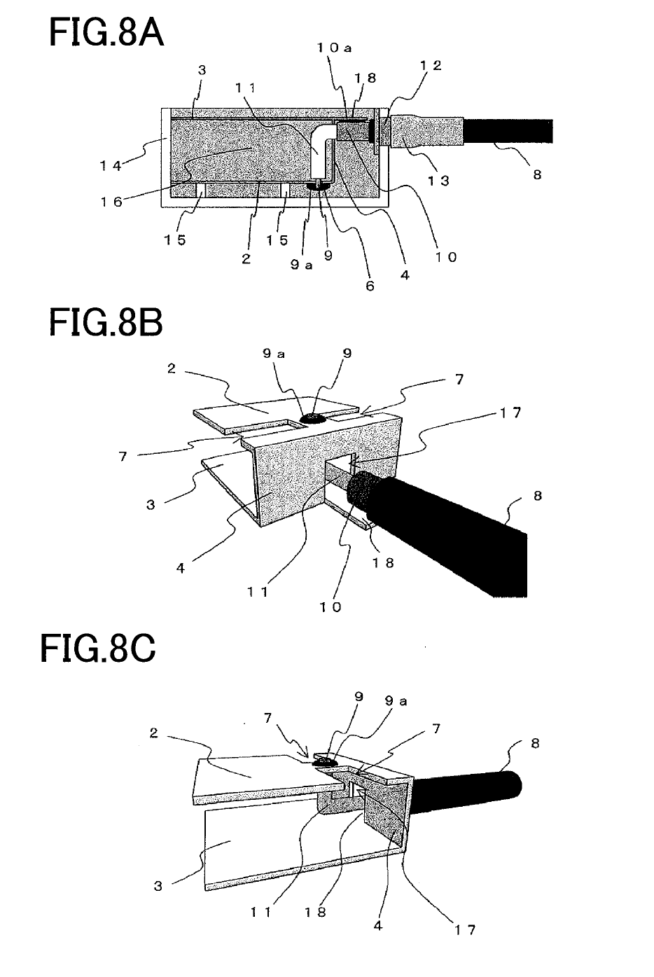

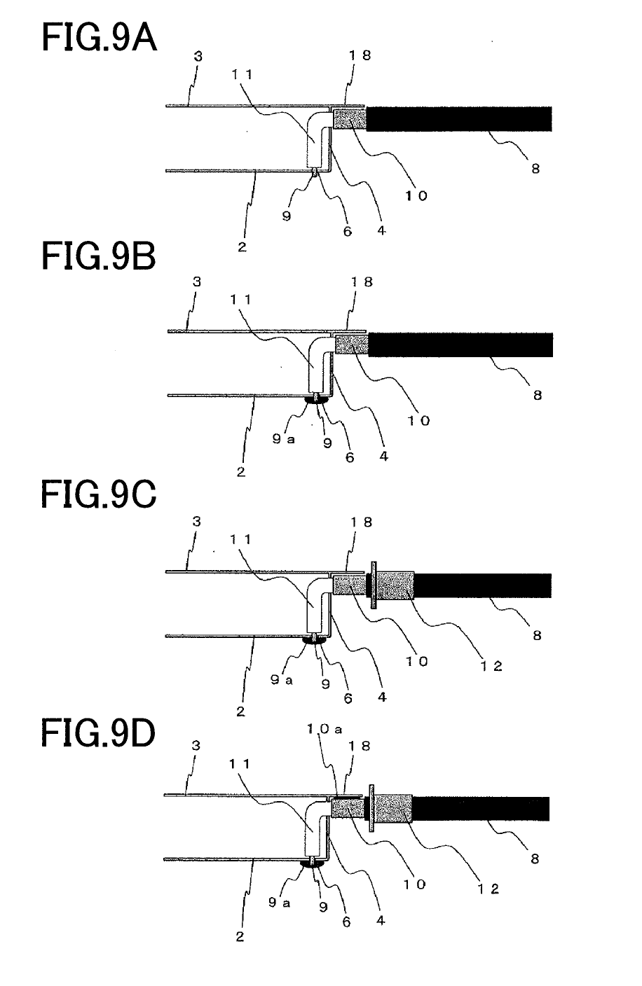

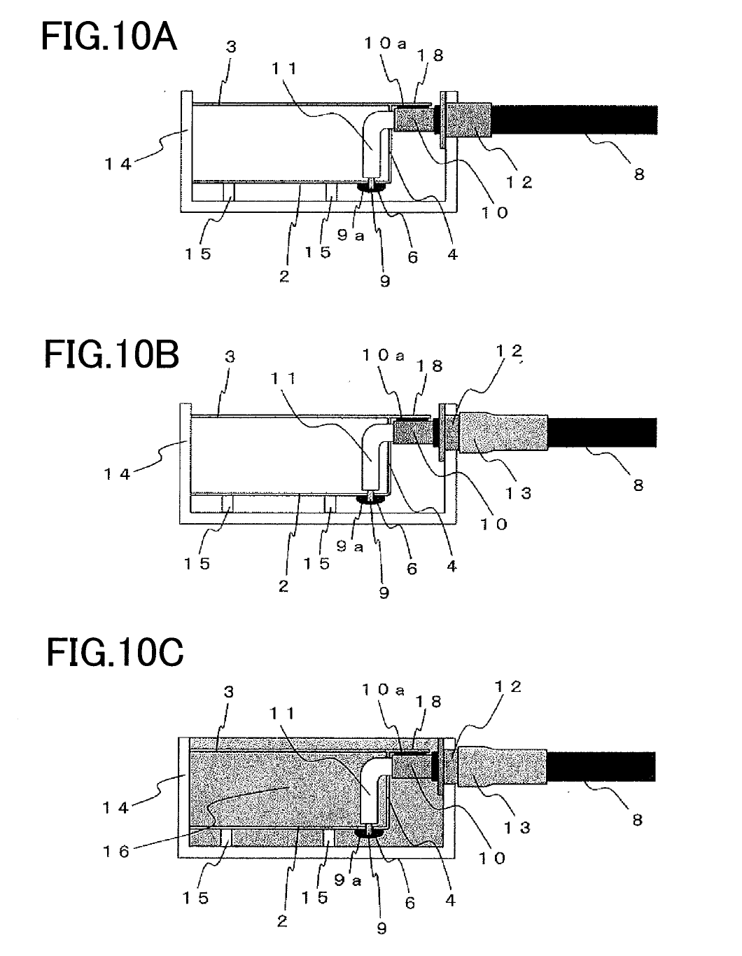

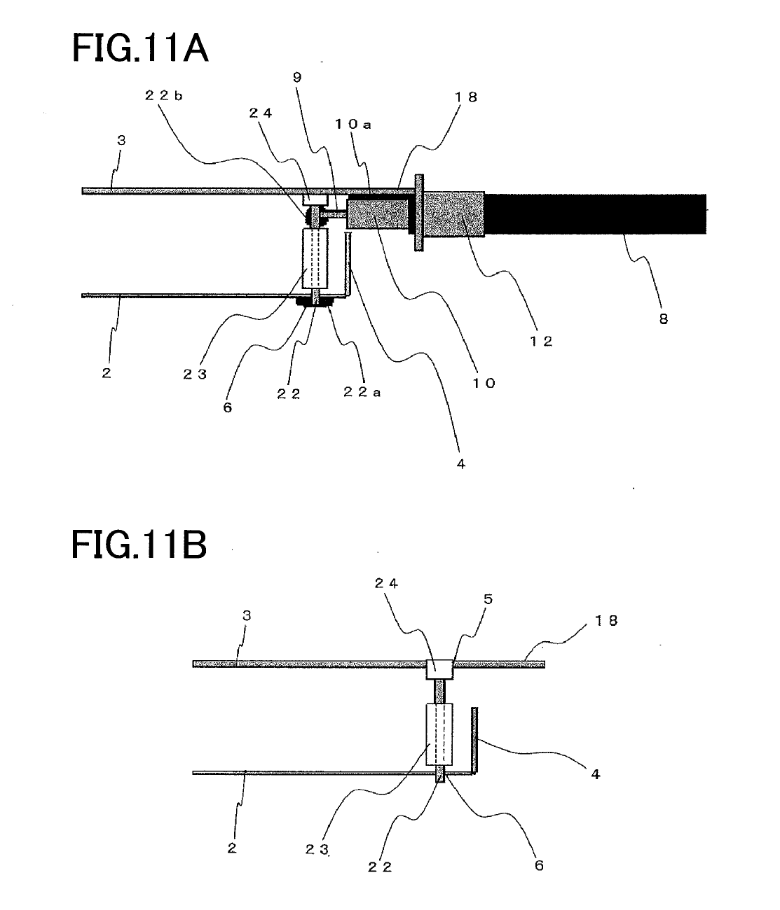

A second embodiment of the present invention will be described with reference to FIGS. 8 through 11. In the first embodiment, the case where the coaxial line 8 (internal conductor 9) is inserted through the hole 5 from the ground conductor plane 3 has been described. In the second embodiment, the case where the coaxial line 8 (internal conductor 9) is inserted through the opening 17 from the short-circuit plane 4 near the ground conductor plane 3 will be described. In such a case, the hole 5 is not necessarily needed. FIG. 8A is a view of an antenna configuration as seen through the side surface of the housing of the shorted patch antenna device; FIGS. 8B and 8C are views of the antenna configuration as seen through the housing and dielectric (resin) of the shorted patch antenna device. FIG. 9A is a view where the coaxial line is inserted into the antenna element; FIG. 9B is a view where the internal conductor of the coaxial line is soldered to the radiation conductor plane of the antenna element; FIG. 9C is a view where the insulating bushing is attached to the coaxial line; and FIG. 9D is a view where the external conductor of the coaxial line is soldered to the external conductor mounting section of the antenna element. FIG. 10A is a view where the antenna element to which the coaxial line is connected is placed in the housing; FIG. 10B is a view where the heat shrinkable tube is attached to the coaxial line; and FIG. 10C is a view where the dielectric resin fills the housing thereby to seal the antenna element. FIG. 11 is a view where the external conductor of the coaxial line is soldered to the external conductor mounting section of the antenna element. In the drawings, the same reference number indicates an identical or corresponding portion, which will not be described in detail.

In a structure of the shorted patch antenna device according to the second embodiment illustrated in FIG. 8, the antenna element in which the radiation conductor plane 2 (patch) is grounded by the short-circuit plane 4 to the ground conductor plane 3, the coaxial line 8 feeds power to the antenna element, and the antenna element is held in the housing 14. The housing 14 encapsulates the resin 16 that fills around the antenna element. Accordingly, since a wavelength shortening effect can be obtained according to a relative permittivity of the resin 16, the antenna element (radiation conductor plane 2) of the shorted patch antenna device can be miniaturized. Further, since the slits 7 cut out in the same direction as a folding direction of the conductor plate 1 are formed on the radiation conductor plane 2 that is a radiation plane of the antenna, the radiation conductor plane 2 can be shortened due to a wavelength shortening effect, thereby further miniaturizing the shorted patch antenna device. These effects are the same as the effects that can be obtained in the structure of the shorted patch antenna device according to the first embodiment.

Since the feeding point of the shorted patch antenna device according to the second embodiment is the same as that in the first embodiment, it will not be described. It should be appreciated that also in the shorted patch antenna device according to the second embodiment, since the external conductor 10 of the coaxial line 8 is grounded to the external conductor mounting section 18 thereby to affix the coaxial line 8 to the housing 14, feeding by the coaxial connector is not necessary thereby to allow for miniaturization of the whole device. In addition, even if the feeding point needs to be moved toward the short-circuit plane 4 due to a dimensional adjustment of the antenna, the feeding point can be easily moved due to a simple structure without a member other than the conductor plate 1 or the aforedescribed coaxial connector. Further, since the hole 5 is not formed, wiring of the coaxial line 8 (a portion of the internal conductor 9 covered with the insulating coating 11) is not restricted by the location of the hole 5, and also since the coaxial line 8 (mainly a portion of the internal conductor 9 covered with the insulating coating 11) is inserted into the folded conductor plate 1, a thickness of the shorted patch antenna device can be thinned. Next, processing of the conductor plate 1 in a method of manufacturing the shorted patch antenna device according to the second embodiment is the same as the conductor plate processing step and conductor plate opposing step described with reference to FIGS. 2 and 3 except that the conductor plate 1 is not necessarily provided with the hole 5, which therefore will not be described.

In the conductor plate processing step and conductor plate opposing step, by mounting (affixing) the coaxial line 8 to the conductor plate 1, the antenna element is completed. The coaxial line mounting step to mount the coaxial line will be described with reference to FIG. 9. First, the internal conductor 9 is exposed from a tip portion of the coaxial line 8, and next to the tip portion, the internal conductor 9 covered with the insulating coating 11 is exposed and the insulating coating 11 covered with the external conductor 10 is then exposed in this order. As illustrated in FIG. 9A, the coaxial line 8 is inserted through the opening 17 into the short-circuit plane 4, the internal conductor 9 of the tip portion of the coaxial line 8 is bent, extended to and is inserted into the hole 6. Next, as illustrated in FIG. 9B, the internal conductor 9 of the tip portion of the coaxial line 8 inserted into the hole 6 is electrically connected and affixed by the electrical connection means 9a. This conducts electricity between the internal conductor 9 of the coaxial line 8 and the radiation conductor plane 2. Conduction between the internal conductor 9 of the coaxial line 8 and the radiation conductor plane 2 may be achieved by soldering the internal conductor 9 of the coaxial line 8 directly to the radiation conductor plane 2 (feeding point portion) without forming the hole 6 in the radiation conductor plane 2. Next, the bushing 12 is attached to the coaxial line 8 (FIG. 9C). Then, as illustrated in FIG. 9D, the external conductor 10 is electrically connected by the electrical connection means 10a to the external conductor mounting section 18 that is a region continuing from a region of the conductor plate 1 (ground conductor plane 3) and extending from a portion at which the ground conductor plane 3 abuts on the opening 17. The order of steps in FIGS. 9B, 9C and 9D is not limited.

By placing the antenna element to which the coaxial line 8 is mounted in the housing 14 and filling the resin 16 around the conductor plate 1, the shorted patch antenna device according to the second embodiment is completed. After the resin 16 becomes solidified, a lid may be attached to the housing 14, or one surface of the solidified resin 16 may be used as an outer shell of the shorted patch antenna device according to the second embodiment, as illustrated in FIG. 10C. The antenna element placement step and sealing step will be described in detail. First, as illustrated in FIGS. 10A and 10B, the radiation conductor plane 2 is placed on the ribs 15 on the bottom of the housing 14 and the bushing 12 is placed on the edge of the housing 14. Next, the heat shrinkable tube 13 is attached to the bushing 12 and coaxial line 8 and subjected to heat treatment thereby to affix the bushing 12 to the coaxial line 8 with the use of the heat shrinkable tube 13. Finally, the resin 16 is injected into the housing 14. During injection, since the resin 16 flows from between the radiation conductor plane 2 and the ground conductor plane 3 of the antenna element into the housing 14 end through the slits 7 (excluding the case where the slits 7 fit onto the ribs 15), vice versa, the resin 16 can efficiently fill the whole housing 14. That is, the housing 14 having excessively large dimensions relative to dimensions of the antenna element is not required, and the housing 14 is used as an outer shell of the shorted patch antenna device according to the first embodiment, thereby directly contribute to miniaturization. In addition, the smaller a diameter of the coaxial line 8 (here, the internal conductor 9 covered with the insulating coating 11) inserted into the opening 17 becomes relative to the opening 17, the larger of an area of a gap of the opening 17 around the inserted coaxial line 8 becomes. Therefore, when the resin 16 is injected into the housing 14, the resin 16 flows from between the radiation conductor plane 2 and the ground conductor plane 3 of the antenna element into the housing 14 end through the gap of the opening 17 around the inserted coaxial line 8, as with the slits 7, or vice versa, the resin 16 can effectively fill within the whole housing 14 (for example, the opening 17 illustrated in FIGS. 8B and 8C). FIG. 10C is a shorted patch antenna device after the resin 16 become solidified.

As described above, in the shorted patch antenna device according to the second embodiment, since the coaxial line 8 (internal conductor 9) is inserted through the opening 17 from the short-circuit plane 4 near the ground conductor plane 3, a thickness direction (a direction along the short-circuit plane 4) of the shorted patch antenna device can be reduced without changing an electrical performance of the antenna, compared with the shorted patch antenna device according to the first embodiment.

Further, in the shorted patch antenna device according to the second embodiment, as with in the variation of the shorted patch antenna device according to the first embodiment, with respect to the internal conductor 9 of the coaxial line 8, a member of a portion at least from the ground conductor plane 3 to the radiation conductor plane 2 may be different from a member of a portion other than the aforementioned portion. The portion other than the aforementioned portion means an unbent internal conductor 9 (portions exposed out of the insulating coating 11), as illustrated in the first embodiment (variation). Here, in FIG. 11, 22 indicates a linear conductor; and 23 indicates a cylindrical insulating coating that coats the linear conductor, the linear conductor 22 is placed in a portion indicated by a dotted line in 23; 24 indicates a spacer that insulates between the linear conductor 22 and the ground conductor plane 3 so as not to be short-circuited; 22a indicates an electrical connection means such as soldering that electrically connects the linear conductor 22 to the radiation conductor plane 2; 22b indicates an electrical connection means such as soldering that electrically connects the linear conductor 22 to the internal conductor 9. In the drawings, the same reference number indicates an identical or corresponding portion, which will not be described in detail.

A variation of the shorted patch antenna device according to the second embodiment will be described with reference to FIG. 11. FIG. 11A is an image illustration (the coaxial line 8 has been already formed) of a cross section of the antenna element to be used for the shorted patch antenna device; and FIG. 11B is an image illustration (without the coaxial line 8) of a cross section of the antenna element to be used for the shorted patch antenna device. Since FIG. 11 corresponds to FIG. 6 (FIG. 11A and FIG. 11B correspond to FIG. 6F and FIG. 6A, respectively), only different points from the first embodiment (variation) and the second embodiment will be described. As illustrated in FIG. 11A, the tip portion of the linear conductor 22 inserted into the hole 6 is electrically connected and affixed by the electrical connection means 22a to thereby conduct electricity between the linear conductor 22 and the radiation conductor plane 2. The tip portion of the internal conductor 9 of the coaxial line 8 and the base end portion (near the ground conductor plane 3) of the linear conductor 22 are electrically connected by the electrical connection means 22b. This base end portion of the linear conductor 22 to which the internal conductor 9 is electrically connected is insulated by the spacer 24 from the ground conductor plane 3 so that the linear conductor 22 and the internal conductor 9 are not short-circuited.

In a method of manufacturing a feeding portion of the shorted patch antenna device according to the second embodiment (variation), the tip portion of the linear conductor 22 coated with the insulating coating 23 is inserted into the hole 6 of the radiation conductor plane 2 with the tip and base end portions exposed, and the spacer 24 is inserted between the base end portion of the linear conductor 22 and the ground conductor plane 3. In this state, the electrical connection means 22a and 22b may be performed. The electrical connection means 22a or the electrical connection means 22b may be performed before inserting the spacer 24, or the electrical connection means 22a may be performed after the tip portion of the linear conductor 22 is inserted into the hole 6 of the radiation conductor plane 2, the spacer 24 is inserted between the base end portion of the linear conductor 22 and the ground conductor plane 3 and the electrical connection means 22b are performed. Further, a counter bore is preliminarily formed in the spacer 24, the base end portion of the linear conductor 22 is inserted into the counter bore thereby to manufacture an integrated linear conductor 22 (including the insulating coating 23) and spacer 24, which may be used as the feeding portion of the shorted patch antenna device according to the second embodiment (variation).

In this second embodiment, “the hole 5 is not necessarily needed”. However, in the case where the aforedescribed integrated spacer 24 and linear conductor 22 is used, the conductor plate 1 (antenna element) whose ground conductor plane 3 has the hole 5 makes it easier to affix the integrated spacer 24 and linear conductor 22, as illustrated in FIG. 11B. In the present invention, since the conductor plate 1 having a certain degree of thickness is used as the antenna element by taking a cross-polarization into consideration, the spacer 24 can be supported by and affixed to the ground conductor plane 3 by setting a diameter of the hole 5 and a diameter of the spacer 24 so that the hole 5 fits onto the spacer 24. Since the spacer 24 (including the linear conductor 22) is affixed by injecting the resin 16 into the housing 14, the hole 5 may not fit onto the spacer 24, but fitting the hole 5 onto the spacer 24 makes it easier to perform the electrical connection means 22a and 22b.

Next, procedures will be described in the case where the integrated spacer 24 and linear conductor 22 is used. The integrated spacer 24 and linear conductor 22 is inserted through the hole 5 into the conductor plate 1. The tip portion of the linear conductor 22 is inserted through the hole 5 (FIG. 11B), the tip portion of the linear conductor 22 inserted into the hole 5 is electrically connected and affixed by the electrical connection means 22a. This conducts electricity between the linear conductor 22 and the radiation conductor plane 2. Conduction between the linear conductor 22 and the radiation conductor plane 2 may be achieved by directly soldering the linear conductor 22 to the radiation conductor plane 2 (feeding point portion) without forming the hole 6 on the radiation conductor plane 2. The tip portion of the internal conductor 9 of the coaxial line 8 is brought into contact with the base end portion (near the hole 5) of the linear conductor 22 through the opening 17. Next, the bushing 12 is attached to the coaxial line 8. Then, the external conductor 10 is electrically connected by the electrical connection means 10a to the external conductor mounting section 18 that is a region continuing from a region of the conductor plate 1 where the hole 6 is formed and extending from a portion at which the region of the conductor plate 1 where the hole 6 is formed abuts on the opening 17, and then the tip portion of the internal conductor 9 of the coaxial line 8 and the base end portion (near the hole 5) of the linear conductor 20 are electrically connected to each other by the electrical connection means 22b.

Also in this second embodiment (variation), by placing the antenna element to which the coaxial line 8 is mounted in the housing 14 and filling the resin 16 around the conductor plate 1, the shorted patch antenna device according to the second embodiment is completed. Since the coaxial line 8 (internal conductor 9) is inserted through the opening 17 from the short-circuit plane 4 near the ground conductor plane 3, a thick direction (a direction along the short-circuit plane 4) of the shorted patch antenna device can be reduced without changing an electrical performance of the antenna, compared with the shorted patch antenna device according to the first embodiment.

### Third Embodiment

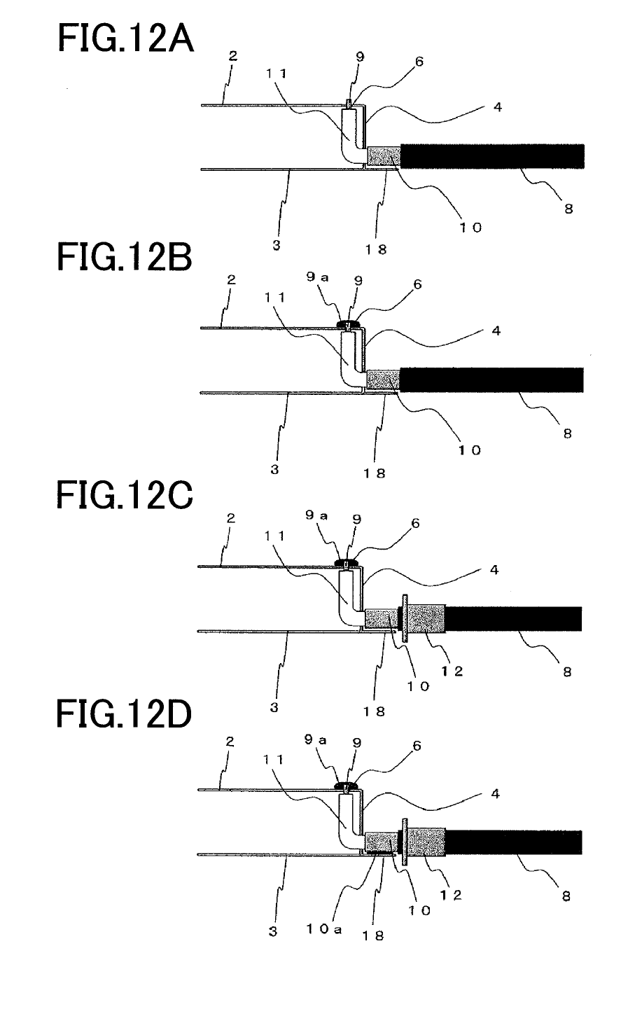

A third embodiment of the present invention will be described with reference to FIGS. 12 through 14. In the first and second embodiments, the radiation conductor plane 2 is placed on the ribs 15 on the bottom of the housing 14 and the bushing 12 is placed on the edge of the housing 14 thereby to manufacture the shorted patch antenna device whereas in the third embodiment, the ground conductor plane 3 is placed on the ribs 15 on the bottom of the housing 14 and the bushing 12 is placed on the edge of the housing 14 thereby to manufacture the shorted patch antenna device, which will be described. As the conductor plate 1 from which the antenna element is formed, the conductor plate 1 described either in the first or second embodiment (including variations) may be used. The third embodiment will be described with reference to the case where the coaxial line 8 is inserted into the opening 17 that is described in the second embodiment. A structure of the shorted patch antenna device according to the third embodiment is the same as the structure of the shorted patch antenna device according to the first and second embodiments (including variations) except the orientation of the antenna element to the housing 14. Operation of the shorted patch antenna device according to the third embodiment is also the same as that according to the first and second embodiments.

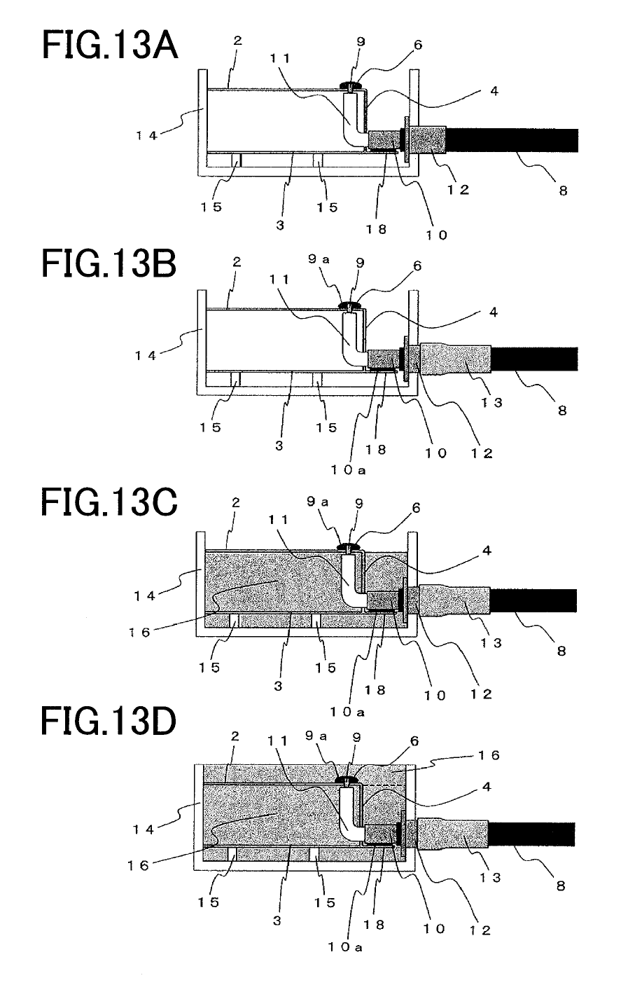

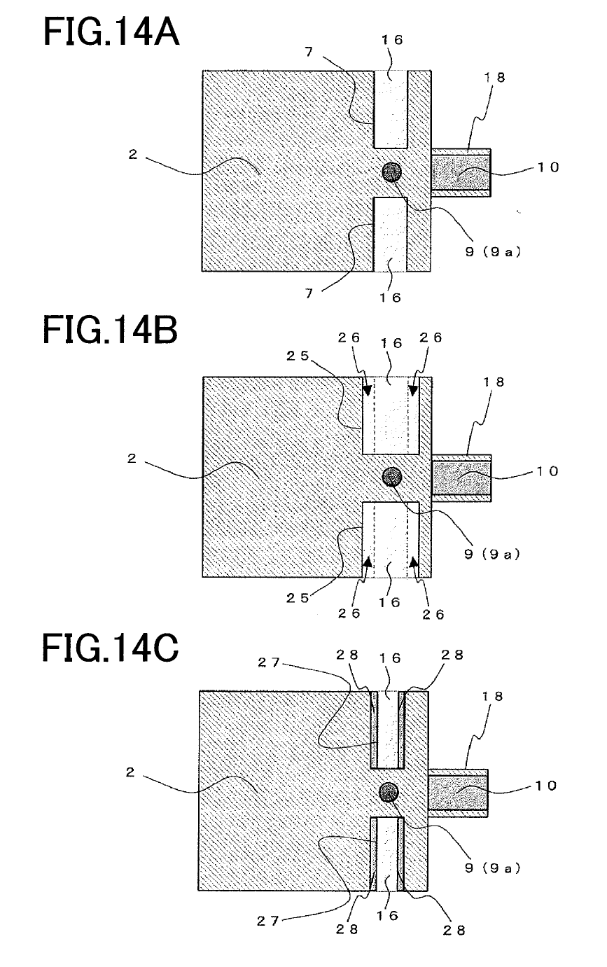

FIG. 12A is a view where the coaxial line is inserted into the antenna element; FIG. 12B is a view where the internal conductor of the coaxial line is soldered to the radiation conductor plane of the antenna element; FIG. 12C is a view where an insulating bushing is attached to the coaxial line; and FIG. 12D is a view where the external conductor of the coaxial line is soldered to the external conductor mounting section of the antenna element. FIG. 13A is a view where the antenna element to which the coaxial line is connected is placed in the housing; FIG. 13B is a view where the heat shrinkable tube is attached to the coaxial line; FIG. 13C is a view where the dielectric resin fills the housing thereby to seal the antenna element (slits are exposed); and FIG. 13D is a view where the dielectric resin fills the housing thereby to seal the antenna element. In FIG. 14, 25 indicates widened slits by scraping off part of the conductor plate 1 at both sides of the slits 7; 26 indicates scraped-off portions of the conductor plate 1; 27 indicates narrowed slits by adding conductor to the conductor plate 1 of both sides of the slits 7; and 28 indicates additional conductor to the conductor plate 1. In the drawings, the same reference number indicates an identical or corresponding portion, which will not be described in detail.

Hereinafter, a method of manufacturing the shorted patch antenna device according to the third embodiment will be described. By mounting (affixing) the coaxial line 8 to the conductor plate 1 that has been subjected to the conductor plate processing and conductor plate opposing, the antenna element is completed. A coaxial line mounting step to mount the coaxial line 8 will be described with reference to FIG. 12. First, the internal conductor 9 is exposed from the tip portion of the coaxial line 8, and next to the tip portion, the internal conductor 9 with the insulating coating 11 is exposed and the insulating coating 11 covered with the external conductor 10 is then exposed in this order. As illustrated in FIG. 12A, the coaxial line 8 is inserted through the opening 17 into the short-circuit plane 4, and the internal conductor 9 of the tip portion of the coaxial line 8 is bent, extended to and is inserted into the hole 6. Next, as illustrated in FIG. 12B, the internal conductor 9 of the tip portion inserted into the hole 6 is electrically connected and affixed by the electrical connection means 9a. This conducts electricity between the internal conductor 9 of the coaxial line 8 and the radiation conductor plane 2. Conduction between the internal conductor 9 of the coaxial line 8 and the radiation conductor plane 2 may be achieved by directly soldering the internal conductor 9 of the coaxial line 8 to the radiation conductor plane 2 (feeding point portion) without forming the hole 6 on the radiation conductor plane 2. Next, the bushing 12 is attached to the coaxial line 8 (FIG. 12C). Then, as illustrated in FIG. 12D, the external conductor 10 is electrically connected by the electrical connection means 10a to the external conductor mounting section 18 that is a region continuing from a region of the conductor plate 1 (ground conductor plane 3) and extending from a portion at which the ground conductor plane 3 abuts on the opening 17. The order of steps in FIGS. 12B, 12C and 12D is not limited.

By placing the antenna element to which the coaxial line 8 is mounted in the housing 14 and filling the resin 16 around the conductor plate 1, the shorted patch antenna device according to the third embodiment is completed. A lid may be attached to the housing 14 after the resin 16 becomes solidified, or one surface of the solidified resin 16 may be used as an outer shell of the shorted patch antenna device according to the third embodiment. An antenna element placement step and a sealing step, which are different from those of other embodiments, will be described in details. As illustrated in FIGS. 13A and 13B, the ground conductor plane 3 is placed on the ribs 15 on the bottom of the housing 14, and the bushing 12 is placed on the edge of the housing 14. Next, the heat shrinkable tube 13 is attached to the bushing 12 and coaxial line 8 and subjected to heat treatment thereby to affix the bushing 12 to the coaxial line 8 with the use of the heat shrinkable tube 13. Finally the resin 16 fills the housing 14. During injection, since the resin 16 flows from between the radiation conductor plane 2 and the ground conductor plane 3 of the antenna element into the housing 14 end through the slits 7, the resin 16 can efficiently fill the whole housing 14.

As illustrated in FIG. 13C, the sealing step according to the third embodiment is completed by filling the resin 16 around the conductor plate 1 in the housing 14 with at least two slits 7 exposed. FIG. 14A is a top view of the shorted patch antenna device after the resin 16 becomes solidified, in which the conductor plate 1 of the shorted patch antenna device is focused. After completing the sealing step according to the third embodiment, in order to examine whether dimensions of the slits 7, which contribute to miniaturization of the antenna element, are suitable or not, electrical (electrical wave) performance of the shorted patch antenna device is actually measured. Based on a result, the following slit adjustment step is performed. If the slits 7 are needed to be widened, the slits 7 of the conductor plate 1 are widened by scraping off portions of (conductor scraped-off portions 26 of) the slits 7 of the conductor plate 1 with the use of a common profile processing machine such as a router thereby to obtain the slits 25, as illustrated in FIG. 14B. If the slits 7 needs to be narrowed, the slits 7 of the conductor plate 1 is narrowed by adding the additional conductor 28 such as a conductor foil and a solder to the slits 7 (achieving electrical conduction between the additional conductor 28 and the conductor plate 1) thereby to obtain the slits 27, as illustrated in FIG. 14C. The slits 27 narrowed by the additional conductor 28 may be adjusted by scraping off part of the additional conductor 28 previously added.

In this way, in the method of manufacturing the shorted patch antenna device according to the third embodiment, since the slit adjustment step is performed after injecting the resin 16 between the radiation conductor plane 2 and the ground conductor plane 3, the slits 7 can be adjusted in a relative permittivity close to that of the finished shorted patch antenna device, and also the slits 7 can be widened without a deviation of an angle between the radiation conductor plane and the ground conductor plane of the conductor plate, which occurs due to lack of resin corresponding to a dielectric substrate in the case where the antenna element of only the conductor plate without resin is processed by scrapping off portions of (conductor scraped-off portions 26) the slits 7 of the conductor plate 1 with the use of the router or the like. Further, slits can be easily narrowed, which is very difficult due to lack of resin corresponding to a dielectric substrate in the case where the antenna element composed of only the conductor plate without the resin is processed. Narrowing is difficult to be performed in the antenna element of only the conductor plate, which obviously hinders miniaturization.

Next, after the slit adjustment step, in a second sealing step in FIG. 13D, the two slits 25 (or the slits 27) are sealed with the resin 16 thereby to obtain the shorted patch antenna device according to the third embodiment. In the aforedescribed slit adjustment step, needless to describe, adjustment may be performed, taking the resin 16 added in the second sealing step into consideration. Further, the slits 25 (or the slits 27) that have been subjected to slit adjustment step may be exposed without performing the second sealing step. If the slits 7 do not need to be adjusted, the slit adjustment step may not be performed. A resin used in the sealing step and the second sealing step is ideally the same resin 16, but different resins can be used.

In the third embodiment, as with the first and second embodiments, the slits 7 face the opening of the housing 14, which has more effect of flowing the resin 16 than the case where the slits 7 face the bottom of the housing 14, as with the first and second embodiments. As with the first and second embodiments, the housing 14 having excessively large dimensions relative to dimensions of the antenna element is not required, and if the housing 14 is used as an outer shell of the shorted patch antenna device according to the first embodiment, thereby directly contributing to miniaturization. In addition, the smaller a diameter of the coaxial line 8 (here, the internal conductor 9 with the insulating coating 11) inserted into the opening 17 becomes relative to the opening 17, the larger an area of a gap of the opening 17 around the inserted coaxial line 8 becomes. Therefore, when the resin 16 is injected into the housing 14, the resin 16 flows from between the radiation conductor plane 2 and the ground conductor plane 3 of the antenna element into the housing 14 end through the gap of the opening 17 around the inserted coaxial line 8, as with the slits 7, or vice versa, the resin 16 can effectively fill within the whole housing 14.

### Fourth Embodiment

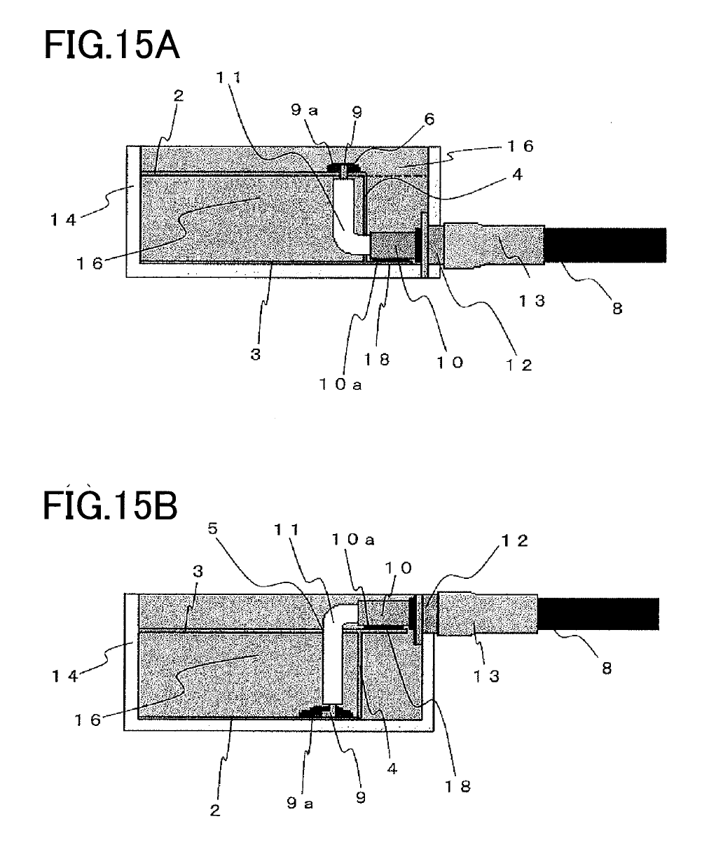

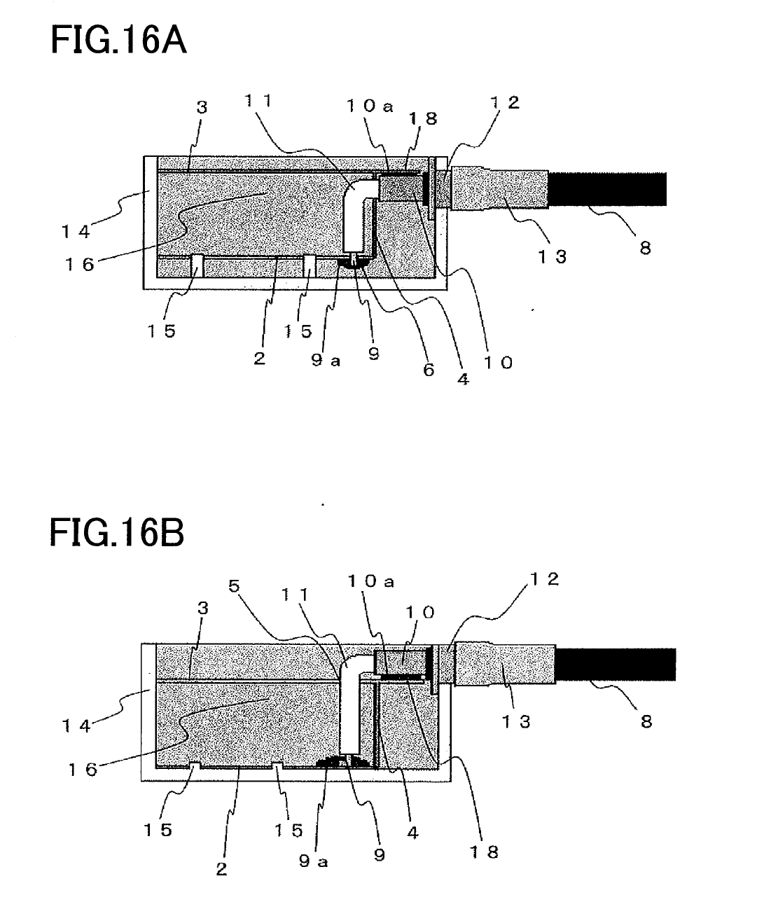

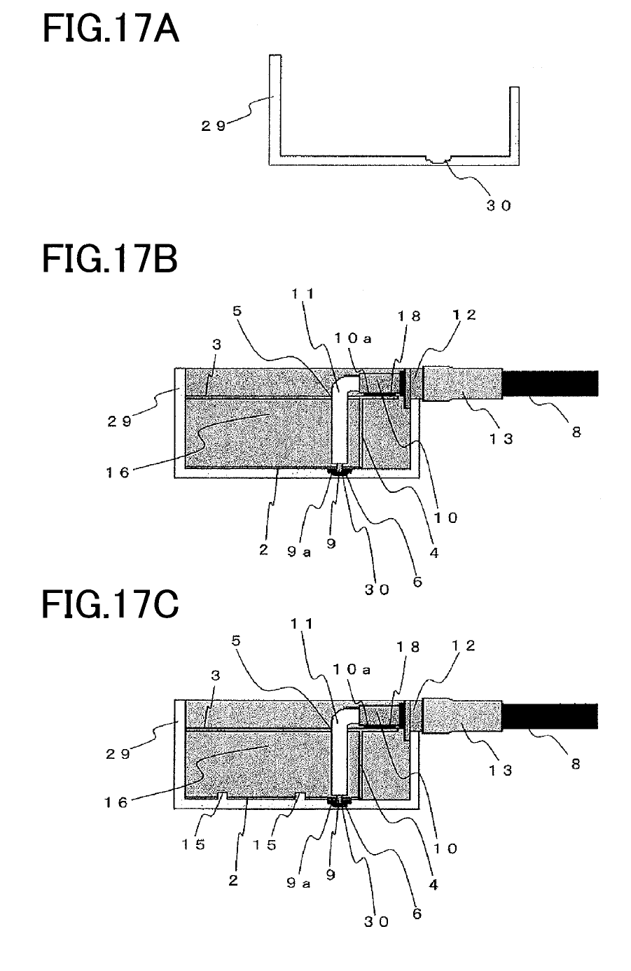

A fourth embodiment of the present invention will be described with reference to FIGS. 15 through 17. With respect to the fourth embodiment, the case where the ribs 15 are not provided and the case where the ribs 15 fit into the slits 7 in the housing of the shorted patch antenna device according to the first through third embodiments will be described (This fitting includes a state where the ribs and slits do not tightly engage with each other.) A structure and operation of the shorted patch antenna device according to the fourth embodiment are the same as the structure and operation of the shorted patch antenna device according to the first through third embodiments (including variations) except the housing. FIG. 15A is a view of an antenna configuration as seen through a side surface of a housing of a shorted patch antenna device (the ground conductor plane is placed on the bottom of the housing); and FIG. 15B is a view of an antenna configuration as seen through a side surface of a housing of a shorted patch antenna device (the radiation conductor plane is placed on the bottom of the housing). FIG. 16A is a view of an antenna configuration as seen through a side surface of a housing of a shorted patch antenna device (the housing has ribs); and FIG. 16B is a view of an antenna configuration as seen through a side surface of a housing of a shorted patch antenna device (the housing has ribs). FIG. 17A is a view of an antenna configuration as seen through a side surface of a housing with a groove; FIG. 17B is a view of an antenna configuration as seen through a side surface of the housing of a shorted patch antenna device (the housing has a groove); and FIG. 17C is a view of an antenna configuration as seen through a side surface of the housing of a shorted patch antenna device (the housing has a groove and ribs).

In FIG. 17, 29 indicates a housing that has an opening and a bottom that are surrounded by side surfaces, the bottom supporting the antenna element, and the edge of the housing is provided with a concave portion or a hole to affix or place the coaxial line 8 (including the bushing 12). The ribs 15 may be integrated to the housing 29, or separate from the housing 29. The housing 29 may not have the ribs 15. 30 indicates a concave portion that is formed on the bottom of the housing 29 and has a shape that can accommodate a projection caused by the electrical connection means 9a on the radiation conductor plane 2. In the drawings, the same reference number indicates an identical or corresponding portion, which will not be described in detail.

In the shorted patch antenna device described in the second and third embodiments (including variations), the antenna element is placed in the housing 14 with the ground conductor plane 3 facing the bottom of the housing 14. In such a case, since the ground conductor plane 3 does not have a projection or a convex portion, a thickness direction (a direction along the short-circuit plane 4) of the shorted patch antenna device can be reduced by placing the ground conductor plane 3 on the bottom of the housing 14 without the ribs 15 in the housing 14 being formed. The shorted patch antenna device in FIG. 15A illustrates such a structure. In this structure, between the ground conductor plane 3 and the housing 14 the resin 16 may exist little or partly.

Next, it will be described that, in the shorted patch antenna device described in the first embodiment (including a variation), the shorted patch antenna device can be configured without forming the ribs 15 in the housing 14. In the shorted patch antenna device according to the first embodiment (including a variation), without inserting the internal conductor 9 of the coaxial line 8 into the hole 6 formed on the radiation conductor plane 2 of the conductor plate 1, the internal conductor 9 of the coaxial line 8 is electrically connected by the electrical connection means 9a to the radiation conductor plane 2 that opposes the ground conductor plane 3. By doing so, since a projection or a convex portion is not formed on the other surface of the radiation conductor plane 2 from the surface opposing the ground conductor plane 3, a thickness direction (a direction along the short-circuit plane 4) of the shorted patch antenna device can be reduced by placing the radiation conductor plane 2 on the bottom end of the housing 14 without forming the ribs 15 in the housing 14. The shorted patch antenna device in FIG. 15B illustrates the structure. In this case, between the radiation conductor plane 2 and the housing 14 the resin 16 may exist little or partly.

Hereinafter, it will be described that, in the shorted patch antenna device described in the first embodiment (including a variation) and the shorted patch antenna device in FIG. 15B, if the antenna element is placed in the housing 14 with the radiation conductor plane 2 opposing the ribs 15, a projection having a shape to fit into the slit 7 may be employed. The shorted patch antenna device illustrated in FIG. 16 uses the conductor plate 1 having two units of the two slits 7 in the same arrangement as that of FIG. 2E as the antenna element. The conductor plate 1 of the shorted patch antenna device in FIG. 16A has the hole 6; and the conductor plate 1 of the shorted patch antenna device in FIG. 16B does not necessarily need the hole 6. Description on the feeding point in FIG. 16B is the same as that on the feeding point in FIG. 15B. Fixing and positioning of the antenna element in the housing 14 become easier by fitting or engaging of the slit 7 and the rib 15 in this way.

Finally, it will be described that, in the shorted patch antenna device described in the second embodiment (including a variation), even if there is a projection on the radiation conductor plane 2 caused by the electrical connection means 9a, a thick direction (direction along the short-circuit plane 4) of the shorted patch antenna device is reduced by removing the ribs 15. The housing 29 illustrated in FIG. 17A has the concave portion 30 on the bottom. The concave portion 30 is placed at the location opposing the feeding point of the radiation conductor plane 2 placed on the bottom of the housing 29. The shape of the concave portion 30 may have any shape that can accommodate the internal conductor 9 and electrical connection means 9a or the projection on the radiation conductor plane 2 caused by the electrical connection means 9a. The concave portion 30 may be substituted by a through hole. With the use of the concave portion 30 including such a through hole, a thick direction (direction along the short-circuit plane 4) of the shorted patch antenna device can be reduced by placing the radiation conductor plane 2 on the bottom of the housing 29 without the ribs 15 being formed on the housing 29, as the shorted patch antenna device in FIG. 17B. It should be appreciated that, the housing 29 may be provided with the ribs 15 as the shorted patch antenna device in FIG. 17C, and the slits 7 and the ribs 15 may be fitted or engaged to each other as with the shorted patch antenna device in FIG. 16, thereby making fixing and positioning of the antenna element in the housing 29 easier.

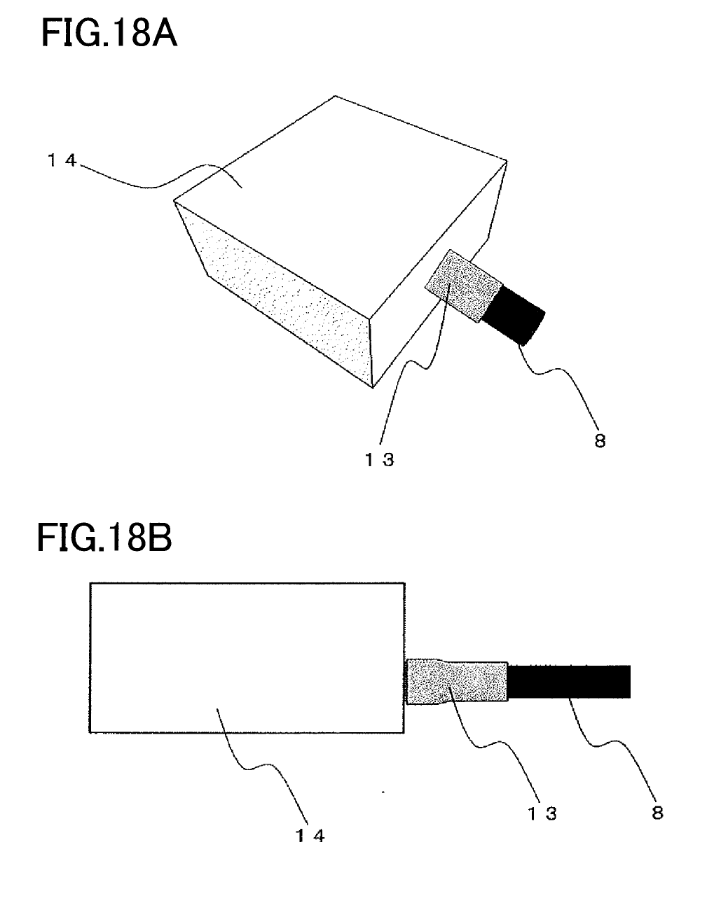

FIG. 18 is an external view of the shorted patch antenna device according to the first through fourth embodiments. FIG. 18A is a perspective view of the shorted patch antenna device according to the first through fourth embodiments; and FIG. 18B is a side view of the shorted patch antenna device according to the first through fourth embodiments. In a conventional shorted patch antenna using a dielectric substrate, the dielectric substrate is subjected to pattern etching in order to manufacture the radiation conductor and ground conductor. Therefore, there is a problem that since a side surface of the dielectric substrate needs a metal to conduct electricity between up and down, manufacturing is difficult, and since connector feeding (feeding that passes through a dielectric substrate) is often needed, a thickness of an antenna including a connector is increased. However, the shorted patch antenna device according to the first through fourth embodiments can solve such a problem. Next, regarding shorted patch antenna manufactured by using sheet metal such as the metal plate and conductor plate, there are the following problems: that miniaturization is difficult due to a hollow structure (a wavelength shortening effect of a dielectric cannot be obtained), a thickness is great due to connector feeding, there is a weak impact resistance, that it is difficult to secure a dimensional tolerance (a thickness of the antenna element is irregular), and that since the antenna element of the sheet metal is unstable, adjustment of dimensions is difficult. However, the shorted patch antenna device according to the first through fourth embodiments can solve these problems.

### Fifth Embodiment

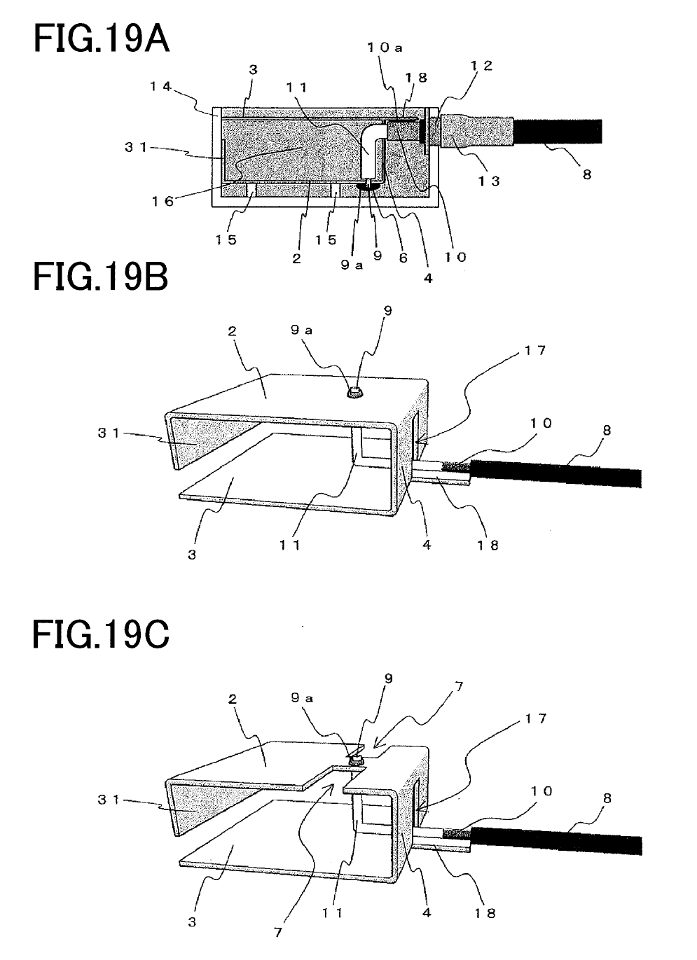

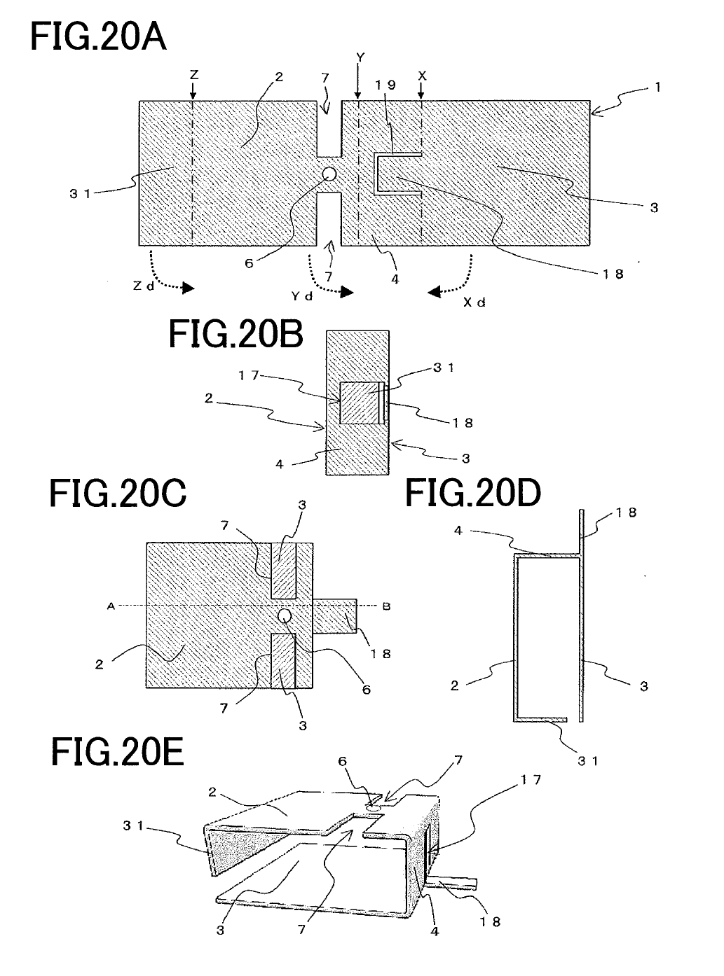

A fifth embodiment according to the present invention will be described in FIGS. 19 through 21. It has been described that, in the shorted patch antenna device according to the first through fourth embodiments, an area of the radiation conductor plane 2 can be miniaturized by the slits 7. In the fifth embodiment, a method that can miniaturize the shorted patch antenna device while increasing an area of the radiation conductor plane 2 will be described. This method and slits 7 may be used together. FIG. 19A is a view of an antenna configuration as seen through a side surface of a housing of the shorted patch antenna device; FIG. 19B is a view of an antenna configuration (without the slits 7) as seen through the housing and a dielectric (resin) of the shorted patch antenna device; and FIG. 19C is a view of an antenna configuration (with the slits 7) as seen through the housing and a dielectric (resin) of the shorted patch antenna device. FIG. 20A is a top view of a single conductor plate that has been subjected to conductor plate processing; FIG. 20B is a view of the single conductor plate that has been subjected to conductor plate opposing, which is seen from the short-circuit plane (opening) end; FIG. 20C is a view of the single conductor plate that has been subjected to conductor plate opposing, which is seen from the radiation conductor plane end; FIG. 20D is a cross sectional view of the conductor plate taken from a dashed-dotted line AB in FIG. 20C; and FIG. 20E is a perspective view of the single conductor plate that has been subjected to conductor plate opposing.

In FIGS. 19 through 21, 31 indicates a matching adjustment plane (including a pre-folded conductor plate 1 for convenience of description) that is a tip portion of the radiation conductor plane 2 bent toward the ground conductor plane 3. A base end portion of the radiation conductor plane 2 is on the short-circuit plane 4 end. Since the matching adjustment plane 31 is formed by folding (bending) the conductor plate 1, the term “plane” is used, as with the radiation conductor plane 2, ground conductor plane 3, and short-circuit plane 4, the matching adjustment plane 31, as the antenna element, may be interpreted as part of the radiation conductor plane 2 that is the radiation conductor 2. The slits 7 reduce an area of the radiation conductor plane 2 by a wavelength shortening effect. Since the radiation conductor of the antenna element can be composed of the matching adjustment plane 31 bent from the radiation conductor plane 2 and the radiation conductor plane 2 by using the matching adjustment plane 31, an area of the radiation conductor plane 2 can be miniaturized while an area of the radiation conductor as the antenna element is secured. In this way, since the matching adjustment plane 31 is formed by bending the tip of the radiation conductor plane 2 toward the ground conductor plane 3, the matching adjustment plane 31 can serve as a miniaturization section, as with the slits 7, that can miniaturize the radiation conductor plane 2, especially, an area of the radiation conductor plane 2 opposing the ground conductor plane 3. In the drawings, the same reference number indicates an identical or corresponding portion, which will not be described in detail.

The antenna element of the shorted patch antenna device according to the fifth embodiment in FIG. 19B has the matching adjustment plane 31, and the antenna element of the shorted patch antenna device according to the fifth embodiment in FIG. 19C has both of the matching adjustment plane 31 and slits 7. For easier comparison of configuration, FIGS. 19B and 19C illustrate the radiation conductor plane 2 having approximately identical dimensions. Practically, however, if the same conductor plate 1 and resin 16 are used, an area of the radiation conductor plane 2 illustrated in FIG. 19C is smaller than an area of the radiation conductor plane 2 illustrated in FIG. 19B. With respect to a strength of the antenna element (conductor plate 1), the antenna element using only the matching adjustment plane 31 is superior to the antenna element using the both of the matching adjustment plane 31 and slits 7 since there is no constricted portion of the conductor plate 1 due to the slits 7. FIG. 20 illustrates steps to form the antenna element having both of the matching adjustment plane 31 and the slits 7. Other embodiments perform the same steps.

Next, a method of manufacturing the shorted patch antenna device according to the fifth embodiment will be described with reference to FIG. 20. Since procedures in the conductor plate processing step is the same as those in the first embodiment described with reference to FIG. 2, only affixing after the conductor plate processing step will be described here. The conductor plate 1 after being subjected to the conductor plate processing is illustrated in FIG. 20A. In order to fold the conductor plate 1 to obtain opposing conductors composing the antenna element, a conductor plate opposing step is performed to cause a region continuing to the external conductor mounting section 18 (if there is the hole 5, the region also can be referred to as a region of the conductor plate 1 where the hole 5 is formed. FIG. 20 illustrates a region when the hole 5 is not formed.) and a region of the conductor plate 1 where the hole 6 and slits 7 are formed to face to each other. The conductor plate opposing step is mainly composed of the first folding step and second folding step illustrated in FIG. 20, and a third folding step to form the matching adjustment plane 31 secondarily occurs. This third folding step may be performed either before or after the first folding step and second folding step, or may be performed after the coaxial line 8 is connected to the antenna element (conductor plate 1).

As with the first embodiment, the order of the first folding step and second folding step is not limited. The first folding step and second folding step may be performed simultaneously, and the aforedescribed conductor plate processing step may also be performed simultaneously. The conductor plate processing step may be performed after the conductor plate opposing step. By subjecting conductor plate processing and conductor plate opposing, the conductor plate 1 can be formed as a configuration in which the external conductor mounting section 18, which is part of the conductor plate 1, extends from a line segment (a side) at which the short-circuit plane 4 having the opening 17 and the ground conductor plane 3 abuts on each other such that the external conductor mounting section 18 projects from the short-circuit plane 4 and ground conductor plane 3, as illustrated in FIGS. 20B through 20E. These processing steps cause the ground conductor plane 3 and the external conductor mounting section 18 to become nearly-horizontal aligned, but they may be angled to each other. If the matching adjustment plane 31 that is obtained in the third folding step is located so as to directly oppose the short-circuit plane 4 (opening 17), the housing 14 is miniaturized.

In the first folding step, the U-shaped notch 19 of the conductor plate 1 is folded at tips of the fork portion thereof so as to convert the U-shaped notch 19 to the opening 17, thereby causing a region of the conductor plate 1 where the U-shaped notch 19 is formed and a region continuing to the external conductor mounting section 18 to be in two different flat planes and causing the ground conductor plane 3 and the short-circuit plane 4 to be angled at a less or equal to 180 degree angle. Specifically, the folding line X illustrated in FIG. 20A is folded in the folding direction of Xd in the first folding step.

In the second folding step, a region between the U-shaped notch 19 or opening 17 and the slits 7 of the conductor plate 1 is folded thereby to cause a region of the conductor plate 1 where the U-shaped notch 19 or opening 17 is formed and a region of the conductor plate 1 where the hole 6 and slits 7 are formed to be in different flat planes and causing the radiation conductor plane 2 and short-circuit plane 4 to be angled at a less or equal to 180 degree angle. Specifically, the folding line Y illustrated in FIG. 20A is folded in the folding direction of Yd in the second folding step.

In the third folding step, an end portion on the opposite side of a region of the conductor plate 1 where the slits 7 are formed from a region of the conductor plate 1 where the U-shaped notch 19 or opening 17 is formed is folded thereby to cause the radiation conductor of the antenna element to be the radiation conductor plane 2 and the matching adjustment plane 31 that are two different flat planes with the radiation conductor plane 2 and the matching adjustment plane 31 being angled at a less or equal to 90 degree angle. Specifically, the folding line Z illustrated in FIG. 20A is folded in the folding direction of Zd in the third folding step.

The conductor plate 1 that has been subjected to conductor plate opposing composes the antenna element. The configuration of the antenna element is illustrated in FIGS. 20B through 20E. FIGS. 20B, 20D and 20E show that the opening 17 is formed on the short-circuit plane 4, and the external conductor mounting section 18 is located on the ground conductor plane 3 end of the opening 17. The matching adjustment plane 31 can be seen through the opening 17. FIGS. 20C and 20E show that the slits 7 are formed on the radiation conductor plane 2. The ground conductor plane 3 can be seen through the slits 7.

The antenna element of the shorted patch antenna device according to the fifth embodiment can be applied to any of the shorted patch antenna device according to the first through fourth embodiments. That is, a method to connect the coaxial line 8 to the antenna element, as well as a method to place the antenna element in the housing 14 and fill the housing 14 with the resin 16 are applicable, which therefore will not be described.

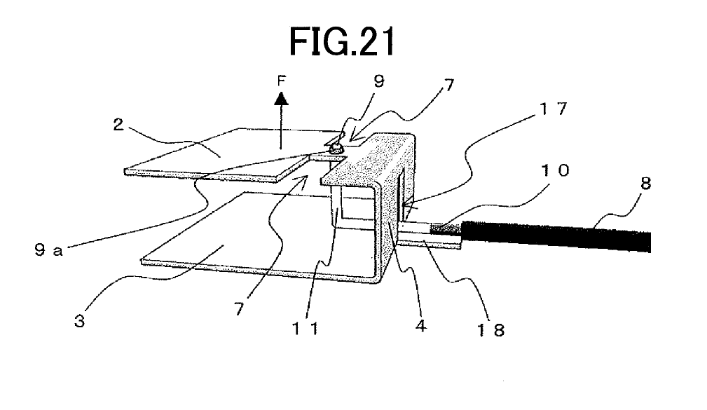

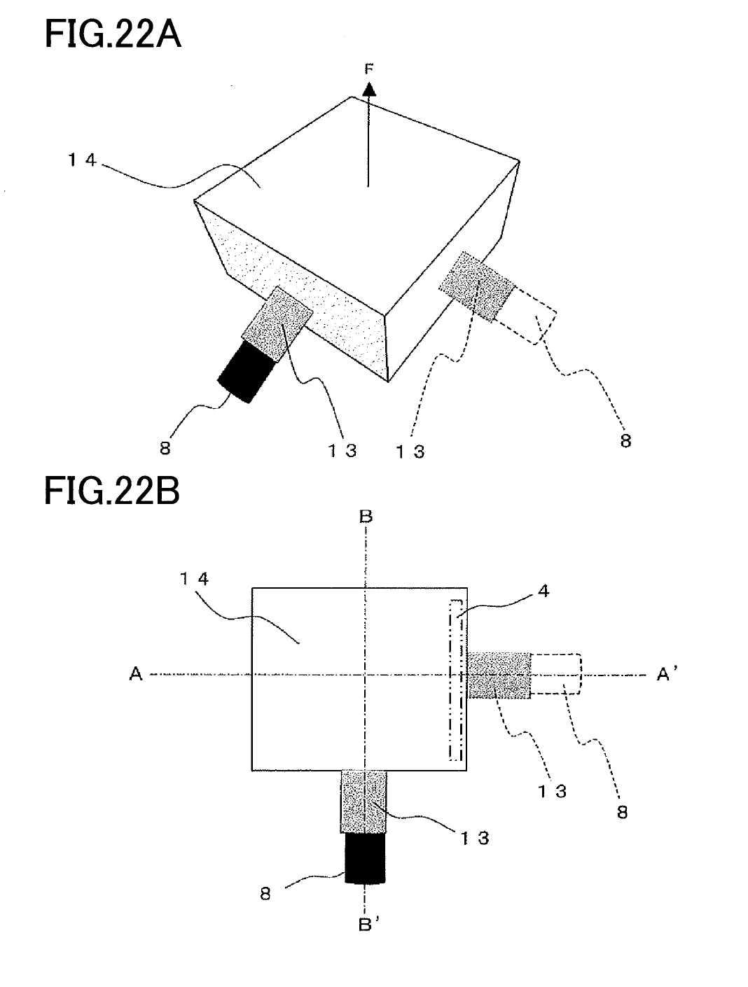

In the shorted patch antenna device according to the first through fifth embodiments, since power can be easily fed directly by a coaxial line such as a coaxial cable, a connector is not needed, thereby reducing a thickness of the antenna device by a thickness of a connector. Further, in the shorted patch antenna device according to the first through fifth embodiments, since a thickness of the conductor can be easily increased, thereby easily increasing a possibility of communication even if a cross-polarization component is increased and a direction of an antenna to be communicated is a direction of the cross-polarization. In the case where communication is mainly performed with an antenna having a polarized wave of the same direction as that of a polarized wave of the shorted patch antenna device illustrated in FIGS. 21 and 22 that will be described later, since a cross-polarization component becomes less necessary, the short-circuit plane 4 may be shortened to reduce a distance between the radiation conductor plane 2 and the ground conductor plane 3, thereby miniaturizing the shorted patch antenna device. Further, since the shorted patch antenna device according to the first through fifth embodiments is molded by the housing and resin (dielectric resin), it has a high environmental resistance, thereby maintaining a stable performance and also has an advantage that dimensions of the antenna do not change very much due to aging degradation and impact.

### Sixth Embodiment

A sixth embodiment of the present invention will be described with reference to FIGS. 22 through 28. In the shorted patch antenna device according to the first through fifth embodiments, since a polarized wave that is parallel to the coaxial line 8 (a direction orthogonal to the short-circuit plane 4) can be mainly only obtained, the shorted patch antenna device has to be placed inclined at a 90 degree angle (that is, in the case where a front face direction F is affixed as illustrated in FIG. 21, that is, the shorted patch antenna device is inclined at a 90 degree angle relative to the front face direction F as an axis). However, since the coaxial line 8 placed on the external conductor mounting section 18 is outside of the housing 14, an arrangement of the shorted patch antenna device can be limited. FIG. 21 described in the fifth embodiment is a view as seen through the housing 14 and resin 16 and shows a relationship between the external conductor mounting section 18 and the coaxial line 8 (where the front face direction F is affixed). The shorted patch antenna device according to the sixth embodiment can easily obtain a polarized wave orthogonal to the coaxial line 8.

FIG. 22A is an external view (perspective view) of the shorted patch antenna device, in which the coaxial line 8 and heat shrinkable tube 13 in the shorted patch antenna device according to the first through fifth embodiments are indicated by a dashed line, and the coaxial line 8 and heat shrinkable tube 13 in the shorted patch antenna device according to the sixth embodiment is indicated by a dashed line. FIG. 22B is an external view (top view) of the shorted patch antenna device, in which the coaxial line 8 and heat shrinkable tube 13 in the shorted patch antenna device according to the first through fifth embodiments are indicated by a dashed line, and the coaxial line 8 and heat shrinkable tube 13 in the shorted patch antenna device according to the sixth embodiment is indicated by a dashed line. A dashed-two dotted line in FIG. 22B illustrates where the short-circuit plane 4 is placed.

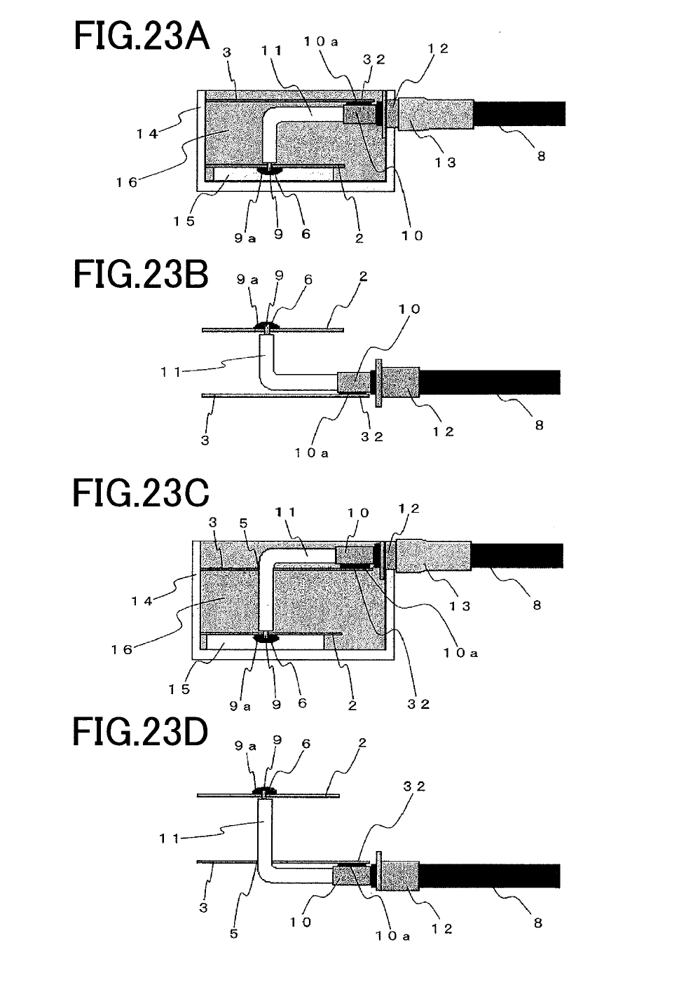

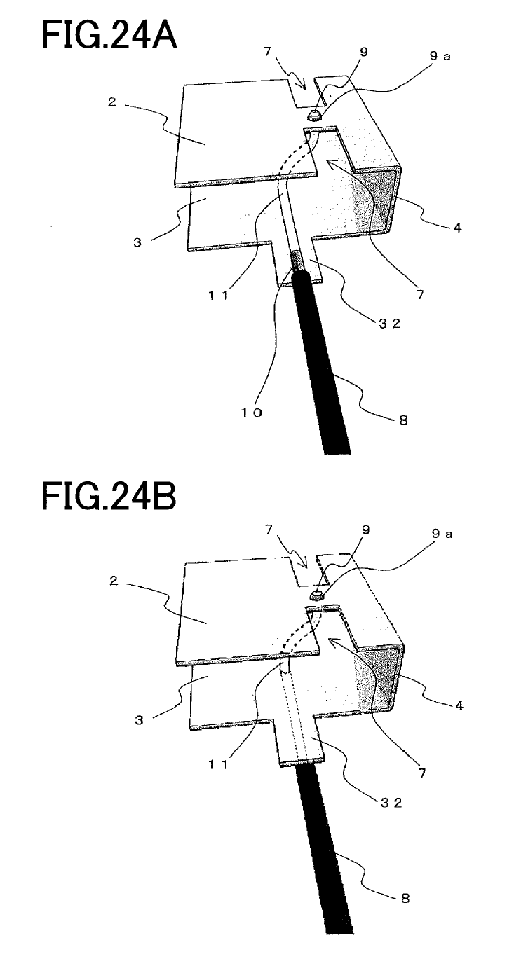

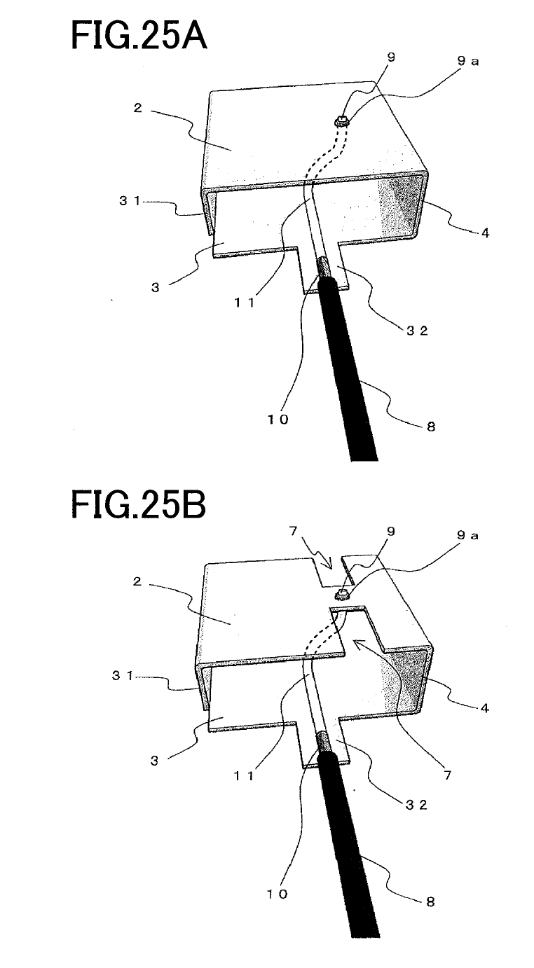

FIG. 23A is a view of an antenna configuration (without the hole 5) as seen through a side surface of the housing of the shorted patch antenna device; FIG. 23B is a view of an antenna configuration (without the hole 5) as seen through the housing and dielectric (resin) of the shorted patch antenna device; FIG. 23C is a view of an antenna configuration (with the hole 5: since the coaxial line 8 (the internal conductor 9 portion covered with the insulating coating 11) is inserted to the hole 5, the reference number of the hole 5 is not shown) as seen through a side surface of the housing of the shorted patch antenna device; and FIG. 23D is a view of an antenna configuration (with the hole: since the coaxial line 8 (the internal conductor 9 portion covered with the insulating coating 11) is inserted to the hole 5, the reference number of the hole 5 is not shown) as seen through the housing and dielectric (resin) of the shorted patch antenna device. FIG. 24A is a view of an antenna configuration (with the slits 7 and without the hole 5) as seen through the housing and dielectric (resin) of the shorted patch antenna device; and FIG. 24B is a view of an antenna configuration (with the slits 7 and hole 5: since the coaxial line 8 (the internal conductor 9 portion covered with the insulating coating 11) is inserted to the hole 5, the reference number of the hole 5 is not shown) as seen through the housing and dielectric (resin) of the shorted patch antenna device. FIG. 25A is a view of an antenna configuration (without the slits 7 and with the matching adjustment plane 31) as seen through the housing and dielectric (resin) of the shorted patch antenna device; and FIG. 24B is a view of an antenna configuration (with the slits 7 and matching adjustment plane 31) as seen through the housing and dielectric (resin) of the shorted patch antenna device.

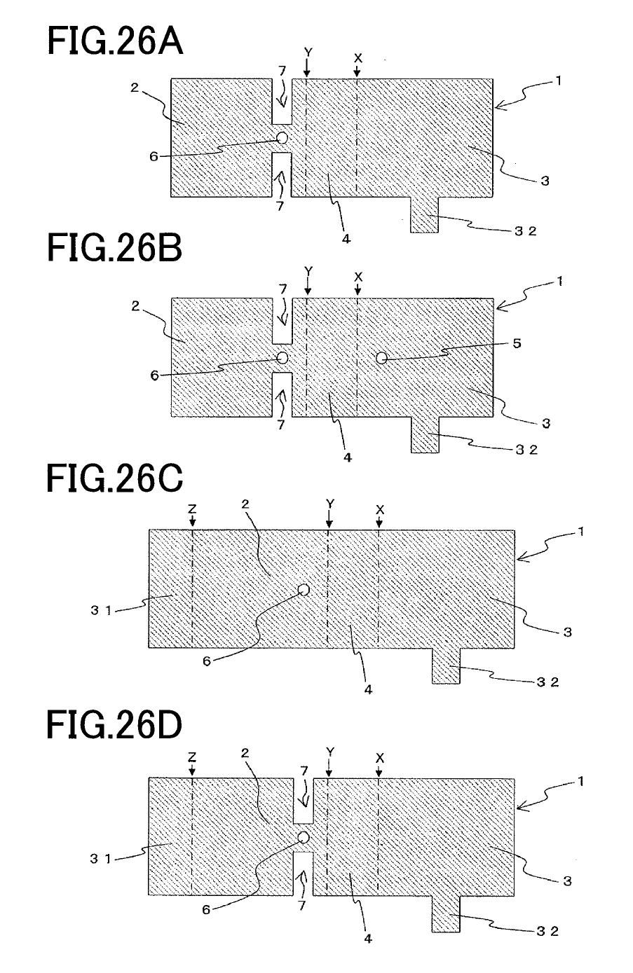

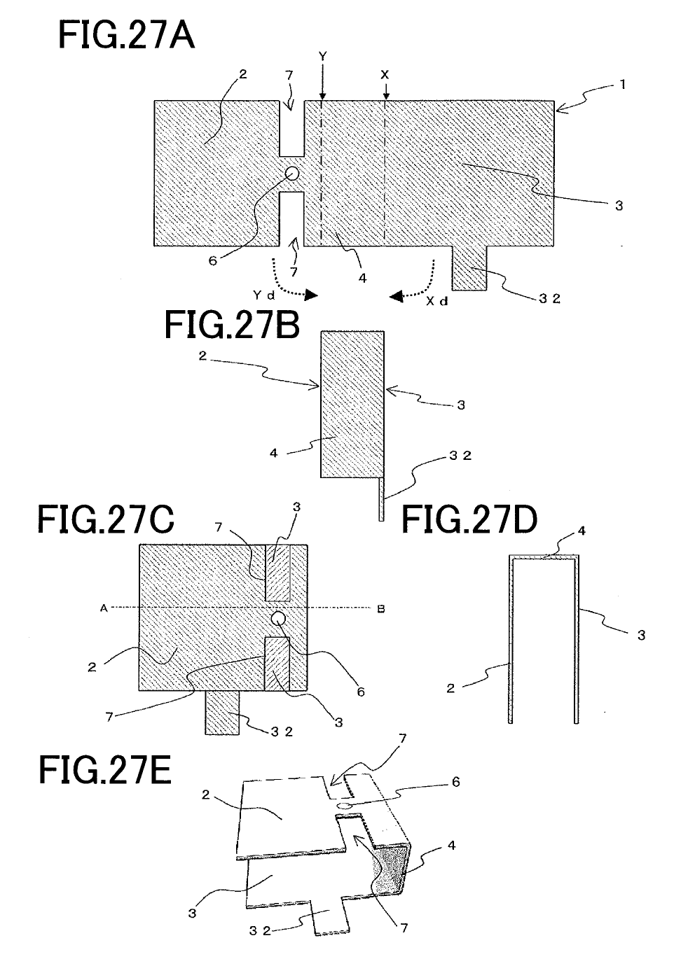

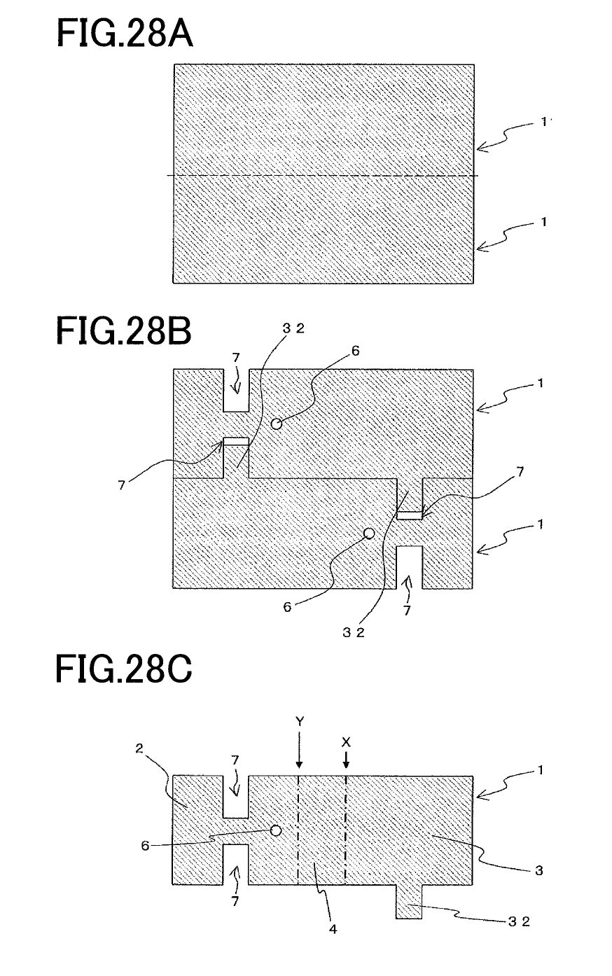

FIG. 26A is a view of the configuration of the conductor plate 1 (with the slits 7 and without the hole 5) before being folded to an antenna element illustrated in FIG. 24A; FIG. 26B is a view of the configuration of the conductor plate 1 (with the slits 7 and hole 5) before being folded to the antenna element illustrated in FIG. 24B; FIG. 26C is a view of the configuration of the conductor plate 1 (without the slits 7 and with the matching adjustment plane 31) before being folded to the antenna element illustrated in FIG. 25A; and FIG. 26D is a view of the configuration of the conductor plate 1 (with the slits 7 and matching adjustment plane 31) before being folded to the antenna element illustrated in FIG. 25B. FIG. 27A is a top view of a single conductor plate that has been subjected to conductor plate processing; FIG. 27B is a single conductor plate that has been subjected to conductor plate opposing, seen from the short-circuit plane end; FIG. 27C is a view of a single conductor plate that has been subjected to conductor plate opposing, seen from the radiation conductor plane end; FIG. 27D is a cross sectional view of the conductor plate illustrated in FIG. 27C taken from the dashed-dotted line AB; and FIG. 27E is a perspective view of a single conductor plate that has been subjected to conductor plate opposing. FIG. 28A is a top view of a conductor plate to obtain integrated two conductor plates; FIG. 28B is a top view of a process to subject the integrated conductor plate to conductor plate processing; and FIG. 28C is a top view of the integrated conductor plates that have been subjected to conductor plate processing (the same as the conductor plate illustrated in FIGS. 26A and 27A).

In FIGS. 22 through 28, 32 indicates the external conductor mounting section (including the pre-folded conductor plate 1 and the conductor plate 1 to which the coaxial line 8 has not contacted yet, for convenience of description) that is part of the conductor plate 1, and extends from a side of the ground conductor plane 3 continuing from a side of the short-circuit plane 4. Since the external conductor mounting section 32 continues from a side of the ground conductor plane 3 orthogonal to a side at which the short-circuit plane 4 and the ground conductor plane 3 abut on each other, the coaxial line 8 is grounded to the ground conductor plane 3 by bringing the external conductor 10 of the coaxial line 8 into contact with the external conductor mounting section 32. The external conductor 10 and the external conductor mounting section 32 are electrically connected by the electrical connection means 10a. Although not illustrated, the external conductor mounting section 32 needs to be electrically connected to a side of the ground conductor plane 3 other than a side at which the short-circuit plane 4 and the ground conductor plane 3 abut on each other. In the drawings, the same reference number indicates an identical or corresponding portion, which will not be described in detail.

In the first through fifth embodiments, a cross sectional view illustrates a cross section (a side surface with respect to a member relating to the coaxial line 8) taken from the dashed-dotted line AA′ in FIG. 22B whereas in the sixth embodiment, a cross sectional view illustrates a cross section (a side surface with respect to a member relating to the coaxial line 8) taken from the dashed-dotted line BB′ in FIG. 22B. Therefore, in a cross sectional view of the shorted patch antenna device according to the sixth embodiment, the short-circuit plane 4 cannot be seen. With respect to the ribs 15, the ribs 15 on the dashed-dotted line BB′ in FIG. 22B are illustrated, and the ribs 15 each has a concave portion that has a shape to be able to accommodate a projection on the radiation conductor plane 2 caused by the electrical connection means 9a, as with the concave portion 30.

In the shorted patch antenna device according to the sixth embodiment, the coaxial line 8 is affixed to the housing 14 by grounding the external conductor 10 of the coaxial line 8 to the external conductor mounting section 32, thereby miniaturizing the whole device without power feeding by a coaxial connector. Even if the feeding point needs to be moved toward the short-circuit plane 4 due to adjustment of dimensions of an antenna, the feeding point can be easily moved since the shorted patch antenna device has a simple structure without a member other than the conductor plate 1 or the aforedescribed coaxial connector. Further, in the shorted patch antenna devices illustrated in FIGS. 23A, 23B, 24A, 25A and 25B, since the hole 5 is not formed, wiring of the coaxial line 8 (the internal conductor 9 portion covered with the insulating coating 11) is not limited by a location of the hole 5 and since the coaxial line 8 (mainly, the internal conductor 9 portion covered with the insulating coating 11) is inserted into the folded conductor plate 1, a thickness of the shorted patch antenna device can be reduced.

Meanwhile, in the shorted patch antenna device in FIG. 24B, since the coaxial line 8 (mainly, the internal conductor 9 portion covered with the insulating coating 11) is inserted through the hole 5 into the folded conductor plate 1, a thickness of the shorted patch antenna device is slightly thicker than that of the shorted patch antenna without the hole 5, but has an advantage to fix the coaxial line 8 more solidly. It should be appreciated that, by forming the hole 5, the shorted patch antenna devices illustrated in FIGS. 23A, 23B, 24A, 25A and 25B may have a structure in which the coaxial line 8 (mainly, the internal conductor 9 portion covered with the insulating coating 11) is inserted through the hole 5 into the folded conductor plate 1.

Next, a method of manufacturing the shorted patch antenna device according to the sixth embodiment will be described with reference to FIG. 27. Here, as one example, the conductor plate 1 illustrated in FIG. 26A will be described. Since procedures of the conductor plate processing step for obtaining the antenna element is the same as those of the first embodiment described with reference to FIG. 2, only affixing after the conductor plate processing step will be described. The conductor plate 1 that has been subjected to the conductor plate processing is illustrated in FIG. 27A. In order to fold this conductor plate 1 thereby to obtain a opposing conductors to compose the antenna element, the conductor plate opposing is performed to cause a region continuing to the external conductor mounting section 32 (also referred to as a region of the conductor plate 1 where the hole 5 is formed if the hole 5 is formed: FIG. 27 illustrates the case without the hole 5 being formed) and a region of the conductor plate 1 where the hole 6 and slits 7 are formed to oppose each other. The conductor plate opposing step is composed of the first folding step and second folding step illustrated in FIG. 27, and the order of the first folding step and second folding step is not limited.

As with the first embodiment, the first folding step and second folding step may be performed simultaneously with the aforedescribed conductor plate processing step. The conductor plate processing step may be performed after the conductor plate opposing step. By subjecting the conductor plate 1 to the conductor plate processing and conductor plate opposing, the conductor plate 1 is formed such that the external conductor mounting section 32, which is part of the conductor plate 1, projects from the ground conductor plane 3 that abuts on the short-circuit plane 4 at a line segment (a side), as illustrated in FIGS. 27B through 27E. This processing steps cause the ground conductor plane 3 and the external conductor mounting section 32 to become nearly-horizontally aligned, but may be separately angled to each other. A difference between the external conductor mounting section 32 and the external conductor mounting section 18 is that a profile of the pre-folded conductor plate 1 is used to configure the external conductor mounting section 32.

In the first folding step, the conductor plate 1 that is folded between a region of the conductor plate 1 that will become the ground conductor plane 3 and a region of the conductor plate 1 that will become the short-circuit plane 4, causes the region of the conductor plate 1 that will become the short-circuit plane 4 and a region of the conductor plate 1 where the external conductor mounting section 32 is formed to be in different flat planes and causes the two planes of the ground conductor plane 3 and the short-circuit plane 4 to be angled at a less or equal to 180 degree angle. Specifically, the folding line X illustrated in FIG. 27A is folded in the folding direction of Xd in the first folding step.

In the second folding step, the conductor plate 1 that is folded between a region of the conductor plate 1 where the slits 7 are formed and a region of the conductor plate 1 that will become the short-circuit plane 4, causes the region of the conductor plate 1 to be the short-circuit plane 4 and a region of the conductor plate 1 where the hole 6 and slits 7 are formed to be in different flat planes and causes the radiation conductor plane 2 and the short-circuit plane 4 to be angled at a less or equal to 180 degree angle. Specifically, the folding line Y illustrated in FIG. 27A is folded in the folding direction of Yd in the second folding step.

The conductor plate 1 that has been subjected to conductor plate opposing composes an antenna element. The configuration of the antenna element is illustrated in FIGS. 27B through 27E. FIGS. 27B and 27E show that the ground conductor plane 3 is provided with the external conductor mounting section 18. FIG. 27D shows that the short-circuit plane 4 is flat. FIGS. 27C and 27E show that the slits 7 are formed on the radiation conductor plane 2. The ground conductor plane 3 can be seen through the slits 7.

The antenna element of the shorted patch antenna device according to the sixth embodiment can be applied to any of the shorted patch antenna device according to the first through fifth embodiments. That is, a method to connect the coaxial line 8 to the antenna element and a method to place the antenna element in the housing 14 and fill the housing 14 with the resin 16 are all applicable, which therefore will not be described.

In the external conductor mounting section 32 of the shorted patch antenna device according to the sixth embodiment, as described above, a profile of the pre-folded conductor plate 1 is used to configure the external conductor mounting section 32. Therefore, compared with the external conductor mounting section 18 of the shorted patch antenna device according to the first through fifth embodiments, the external conductor mounting section 32 can be obtained relatively easier since there is no need to form the notch 19 on the conductor plate 1, but since a profile of the conductor plate 1 needs to be provided with a projection, an area of the conductor plate 1 is increased.

Then, in the shorted patch antenna device with the slits 7 of the shorted patch antenna device according to the sixth embodiment, in the case where one conductor plate 1 is cut to obtain two conductor plates 1, the slit 7 and external conductor mounting section 32 of the pre-folded conductor plate 1 are positioned such that when one of the two conductor plates 1 is rotated by 180 degrees, the external conductor mounting section 32 of the one conductor plate 1 is fitted into the slit 7 of the other conductor plate 1, as illustrated in FIG. 28B, which allows for using the conductor plate 1 having the same area of the conductor plate 1 used in the shorted patch antenna device according to the first through fifth embodiments.

### INDUSTRIAL APPLICABILITY

The shorted patch antenna device and a method to manufacture therefor according to the present invention are applicable to an antenna to be used in a wireless communication device.

1. A shorted patch antenna device comprising:
an antenna element that is composed of a folded single conductor plate and has a radiation conductor plane formed on one of opposing planes of the conductor plate and a ground conductor plane formed on the other of the opposing planes of the conductor plate;
a miniaturization section that is composed of a slit formed by cutting out a side of the radiation conductor plane or a matching adjustment plane formed by bending a tip of the radiation conductor plane toward the ground conductor plane;
a coaxial line whose internal conductor extending from the ground conductor plane end to the radiation conductor plane is electrically connected to the radiation conductor plane and whose external conductor is grounded to the ground conductor plane; and
a resin that fills between the radiation conductor plane and the ground conductor plane of the antenna element.

2. The shorted patch antenna device according to claim 1, comprising a hole formed on the ground conductor plane,
wherein the internal conductor extending through the hole to the radiation conductor plane is electrically connected to the radiation conductor plane.

3. The shorted patch antenna device according to claim 1, wherein the conductor plate composing the antenna element comprises a short-circuit plane that short-circuits the radiation conductor plane and the ground conductor plane; and
an external conductor mounting section that continues from a side of the ground conductor plane other than a side at which the short-circuit plane and the ground conductor plane abut on each other,
wherein, by bringing the external conductor into contact with the external conductor mounting section, the coaxial line is grounded to the ground conductor plane.

4. The shorted patch antenna device according to claim 1, wherein the conductor plate composing the antenna element comprises: a short-circuit plane that short-circuits the radiation conductor plane and the ground conductor plane, the short-circuit plane being provided with an opening cut out to at least to the ground conductor plane; and
an external conductor mounting section that is part of the conductor plate and extends from a portion at which the ground conductor plane abuts on the opening;
wherein by bringing the external conductor into contact with the external conductor mounting section, the coaxial line is grounded to the ground conductor plane.

5. The shorted patch antenna device according to claim 2, wherein the internal conductor of the coaxial line is composed of different members; that is a member of a portion at least from the hole to the radiation conductor plane and a member of a portion other than the aforementioned portion.

6. The shorted patch antenna device according to claim 5, wherein, in the internal conductor of the coaxial line, the portion from the hole to the radiation conductor plane is covered with a cylindrical insulating coating and is insulated by the insulating coating from the ground conductor plane where the hole is formed.

7. The shorted patch antenna device according to claim 4, wherein the internal conductor extending through the opening to the radiation conductor plane is electrically connected to the radiation conductor plane.

8. The shorted patch antenna device according to claim 4, wherein the external conductor mounting section is placed at the same flat plane as the ground conductor plane.

9. The shorted patch antenna device according to claim 1, wherein the resin is filled at least with the slit of the antenna element being exposed.

10. The shorted patch antenna device according to claim 9, wherein the slit is sealed by a second resin.

11. The shorted patch antenna device according to claim 1, wherein the slit is formed so as to oppose each other, from both of two opposing sides of the radiation conductor plane.

12. The shorted patch antenna device according to claim 11, wherein the two slits are formed such that a plurality of two slits are formed along the two opposing sides of the radiation conductor plane.

13. A method of manufacturing a shorted patch antenna device comprising:
a conductor plate processing step to form a U-shaped notch on a conductor plate and a slit in a region opposing with respect to a region of the conductor plate where the U-shaped notch is formed to a region of the conductor plate surrounded by the U-shaped notch, the slit being formed by cutting out a side of the conductor plate;
a first folding step to fold tips of a fork portion of the U-shaped notch on the conductor plate so as to convert the U-shaped notch to an opening, thereby causing a region of the conductor plate where the U-shaped notch is formed and a region on the opposite side of a region of the conductor plate where the U-shaped notch is formed from a region of the conductor plate where the slit is formed to be in different flat planes;
a second folding step to fold the conductor plate between the U-shaped notch or the opening and the slit, thereby causing a region of the conductor plate where the U-shaped notch or the opening is formed and a region of the conductor plate where the slit is formed to be in different flat planes;
a conductor plate opposing step to allow a region of the conductor plate where the slit is formed and a region opposing with respect to a region of the conductor plate where the U-shaped notch is formed to the region of the conductor plate where the slit is formed opposite each other;
a coaxial line mounting step to affix a coaxial line to the conductor plate in such a way that an external conductor is electrically connected to an external conductor mounting section and an internal conductor extends through the opening and is electrically connected to a region of the conductor plate where the slit is formed, the external conductor mounting section that continues from a region on the opposite side of a region of the conductor plate where the U-shaped notch is formed to a region of the conductor plate where the slit is formed and extends from a portion at which the region on the opposite side abuts on the opening;
a sealing step to fill a resin around the conductor plate at least with the slit being exposed, after the coaxial line mounting step; and
a slit adjustment step to change dimensions of the slit after the sealing step.

14. The method of manufacturing a shorted patch antenna device according to claim 13, wherein in the conductor plate processing step, a hole is formed in a region of the conductor plate opposing with respect to a region of the conductor plate where the U-shaped notch is formed to a region of the conductor plate where the slit is formed.

15. The method of manufacturing a shorted patch antenna device according to claim 13, wherein in the slit adjustment step, the slit is widened by scraping off part of the conductor plate, or narrowed by adding a conductor foil or a solder to the conductor plate.

16. The method of manufacturing a shorted patch antenna device according to claim 13, comprising a second sealing step to seal the slit, after the slit adjustment step.

17. The method of manufacturing a shorted patch antenna device according to claim 13, wherein in the conductor plate processing step, two opposing slits from both of two opposing sides of the conductor plate are formed.

18. The method of manufacturing a shorted patch antenna device according to claim 17, wherein in the conductor plate processing step, a plurality of two slits are formed along the two opposing sides of the radiation conductor plane.
